(19) United States
(12) Patent Application Publication
(10) Pub. No.: US 2022/0347930 A1
(43) Pub. Date: Nov. 3, 2022

(54) SIMULATION, CORRECTION, AND DIGITALIZATION DURING OPERATION OF AN ADDITIVE MANUFACTURING SYSTEM

(71) Applicant: Ahead Wind Inc., Denver, CO (US)

(72) Inventors: Robert Paddock, Denver, CO (US); Jacob Goldman, Denver, CO (US); Isaiah James Silva, Denver, CO (US)

(21) Appl. No.: 17/733,556

(22) Filed: Apr. 29, 2022

Related U.S. Application Data
(60) Provisional application No. 63/182,275, filed on Apr. 30, 2021.

(51) Int. Cl. B29C 64/393; B33Y 50/02

(52) U.S. Cl. CPC B29C 64/393; B33Y 50/02; B29C 64/118

(57) ABSTRACT

Examples described herein provide a computer-implemented method that includes receiving fabrication data from an additive manufacturing system during fabrication of an object by the additive manufacturing system. The fabrication data is collected by a sensor associated with the additive manufacturing system during the fabrication of the object. The method further includes generating a digital representation of the fabrication data. The method further includes adjusting, based at least in part on the digital representation, an aspect of the additive manufacturing system. The method further includes implementing the adjusted aspect during the fabrication of the object by the additive manufacturing system.

### CROSS-REFERENCE TO RELATED APPLICATIONS

This application claims the benefit of U.S. Provisional Patent Application No. 63/182,275 filed Apr. 30, 2021, the disclosure of which is incorporated herein by reference in its entirety.

### FIELD OF THE INVENTION

The subject matter described herein generally relate to additive manufacturing systems and more specifically to simulation, correction, and digitalization during operation of an additive manufacturing system and/or a machine learning platform for additive manufacturing systems.

### BACKGROUND

Current additive manufacturing systems include fused filament fabrication (FFF)/fused deposition modeling (FDM), stereolithography (SLA), directed energy deposition (DED), selective laser sintering (SLS), digital light projector (DLP) printers, paste or aerosol jet, and direct metal laser melting (DMLS) deposition technologies, one or more robotic actuators, and other tools for depositing multi-materials such as structural or functional thermoplastics, resins and metals, solid or flexible, conductive and insulating inks, pastes and other nano-particle materials. Such additive manufacturing systems also include tools for sintering, aligning/measuring, milling, drilling, and component pick-and-place tools for placement of components such as electronic, electro-mechanical, or mechanical devices. Some additive manufacturing systems include one or more sensors for collecting data about a fabrication process and/or about an object being fabricated.

Accordingly, while existing additive manufacturing systems are suitable for their intended purposes the need for improvement remains, particular in providing an additive manufacturing system having the features described herein.

### SUMMARY

In one exemplary embodiment, a method is provided. The method includes receiving fabrication data from an additive manufacturing system during fabrication of an object by the additive manufacturing system. The fabrication data is collected by a sensor associated with the additive manufacturing system during the fabrication of the object. The method further includes generating a digital representation of the fabrication data. The method further includes adjusting, based at least in part on the digital representation, an aspect of the additive manufacturing system. The method further includes implementing the adjusted aspect during the fabrication of the object by the additive manufacturing system.

In addition to one or more of the features described herein, or as an alternative, further embodiments of the method may include that the sensor is a contact image sensor.

In addition to one or more of the features described herein, or as an alternative, further embodiments of the method may include that the fabrication data is collected during the fabrication of a layer of the object.

In addition to one or more of the features described herein, or as an alternative, further embodiments of the method may include that the adjusted aspect is implemented during the fabrication of the layer of the object.

In addition to one or more of the features described herein, or as an alternative, further embodiments of the method may include that the adjusted aspect is implemented during the fabrication of a subsequent layer of the object.

In addition to one or more of the features described herein, or as an alternative, further embodiments of the method may include that the fabrication data is collected after the fabrication of a layer of the object and before the fabrication of a subsequent layer of the object.

In addition to one or more of the features described herein, or as an alternative, further embodiments of the method may include that the adjusted aspect is implemented during the fabrication of the subsequent layer of the object.

In another exemplary embodiment another method includes receiving fabrication data from an additive manufacturing system. The fabrication data relates to a first fabrication job. The fabrication data is collected by a sensor associated with the additive manufacturing system during fabrication of an object. The method further includes generating a digital representation of the fabrication data. The method further includes analyzing the fabrication data against a theoretical result. The method further includes causing a second fabrication job to be performed based on analyzing the fabrication data against the theoretical result.

In addition to one or more of the features described herein, or as an alternative, further embodiments of the method may include training a machine learning model based at least in part on the fabrication data, wherein causing the second fabrication job to be performed is further based on an output of the machine learning model.

In addition to one or more of the features described herein, or as an alternative, further embodiments of the method may include that the digital representation represents path of a print head of the additive manufacturing system during the first fabrication job.

In addition to one or more of the features described herein, or as an alternative, further embodiments of the method may include that the path is represented based on a temperature of a print material extruded by the print head.

In addition to one or more of the features described herein, or as an alternative, further embodiments of the method may include that the fabrication data comprise key process parameters.

In addition to one or more of the features described herein, or as an alternative, further embodiments of the method may include that the digital representation represents the key process parameters.

In addition to one or more of the features described herein, or as an alternative, further embodiments of the method may include analyzing the digital representation to detect a defect of an object fabricated during the first fabrication job.

In yet another exemplary embodiment a computer program product includes a computer readable storage medium having program instructions embodied therewith, wherein the computer readable storage medium is not a transitory signal per se, the program instructions executable by a processing device to cause the processing device to perform operations. The operations include receiving fabrication data from an additive manufacturing system during fabrication of an object by the additive manufacturing system. The fabrication data is collected by a sensor associated with the additive manufacturing system during the fabrication of the object. The operations include generating a digital representation of the fabrication data. The operations include adjusting, based at least in part on the digital representation, an aspect of the additive manufacturing system. The operations include implementing the adjusted aspect during the fabrication of the object by the additive manufacturing system.

In addition to one or more of the features described herein, or as an alternative, further embodiments of the computer program product may include that the sensor is a contact image sensor.

In addition to one or more of the features described herein, or as an alternative, further embodiments of the computer program product may include that the fabrication data is collected during the fabrication of a layer of the object.

In addition to one or more of the features described herein, or as an alternative, further embodiments of the computer program product may include that the adjusted aspect is implemented during the fabrication of the layer of the object.

In addition to one or more of the features described herein, or as an alternative, further embodiments of the computer program product may include that the adjusted aspect is implemented during the fabrication of a subsequent layer of the object.

In addition to one or more of the features described herein, or as an alternative, further embodiments of the computer program product may include that the fabrication data is collected after the fabrication of a layer of the object and before the fabrication of a subsequent layer of the object, wherein the adjusted aspect is implemented during the fabrication of the subsequent layer of the object.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following descriptions should not be considered limiting in any way. With reference to the accompanying drawings, like elements are numbered alike:

FIG. 1 depicts a block diagram of a system for simulation, correction, and visualization during operation of an additive manufacturing system according to one or more embodiments described herein;

FIGS. 2A and 2B depict flow diagrams of methods for additive manufacturing according to one or more embodiments described herein;

FIG. 3A depicts an example of an image of scan data captured by a sensor associated with an additive manufacturing system for an object being fabricated according to one or more embodiments described herein;

FIG. 3B depicts an example of an image of simulated data of the object being fabricated according to one or more embodiments described herein;

FIG. 3C depicts an example of an image of combined scan data and simulated data from FIGS. 3A and 3B respectively according to one or more embodiments described herein;

FIG. 3D depicts an example of an image generated by a machine vision algorithm identifying problem regions by comparing the data from FIGS. 3A and 3B respectively according to one or more embodiments described herein;

FIG. 4 depicts a 3D temperature visualization of a first layer of an object being fabricated according to one or more embodiments described herein;

FIG. 5 depicts a 3D temperature visualization of an object being fabricated according to one or more embodiments described herein;

FIG. 6 depicts a part being fabricated according to one or more embodiments described herein;

FIG. 7 depicts a top down view of a 3D part being fabricated according to one or more embodiments described herein;

FIG. 8 depicts a sequential temperature by line number graph associated with FIG. 5 according to one or more embodiments described herein;

FIG. 9 depicts a table of results of the analysis at a glance according to one or more embodiments described herein;

FIG. 10 depicts a table of print statistics and a table of temperature statistics according to one or more embodiments described herein;

FIG. 11 depicts a calibration cube 3D temperature visualization according to one or more embodiments described herein;

FIG. 12 depicts a sequential temperature by line number graph associated with FIG. 8 according to one or more embodiments described herein;

FIG. 13 depicts a temperature occurrence histogram in degrees Celsius for the calibration cube 3D temperature visualization of FIG. 11 according to one or more embodiments described herein;

FIG. 14 depicts a first layer of the calibration cube of FIG. 8 according to one or more embodiments described herein;

FIG. 15 depicts 3D temperature visualization of a failed benchmark layer according to one or more embodiments described herein;

FIG. 16 depicts a table of print statistics and a table of temperature statistics according to one or more embodiments described herein;

FIG. 17 depicts a calibration cube 3D temperature visualization according to one or more embodiments described herein;

FIG. 18 depicts a sequential temperature by line number for the calibration cube 3D temperature visualization of FIG. 17 according to one or more embodiments described herein;

FIG. 19 depicts a temperature occurrence histogram for the calibration cube 3D temperature visualization of FIG. 17 according to one or more embodiments described herein;

FIG. 20 depicts a benchmark critical region for the calibration cube 3D temperature visualization of FIG. 17 according to one or more embodiments described herein;

FIG. 21 depicts a block diagram of a processing system for implementing one or more embodiments described herein;

FIG. 22 depicts a block diagram of components of a machine learning training and inference system according to one or more embodiments described herein;

FIG. 23A depicts an image of a scan using a sensor of the internal features of a 3D printed part showing failures according to one or more embodiments described herein;

FIG. 23B depicts an image of a scan using a sensor of the internal features of a 3D printed part showing failures according to one or more embodiments described herein; and

FIG. 24 depicts an example of the print results before the use of the simulation tool and the print results after corrections are made to the printing process according to one or more embodiments described herein.

### DETAILED DESCRIPTION

A detailed description of one or more embodiments of the disclosed apparatus and method are presented herein by way of exemplification and not limitation with reference to the Figures.

One or more embodiments are provided for simulating, correcting, and digitalization of additive manufacturing of an object. According to one or more embodiments described herein, the simulating, correcting, and digitalization can be performed in real-time (or near-real-time) during fabrication (e.g., while an additive manufacturing system is fabricating the object). According to one or more embodiments described herein, digitizing can include generating a digital representation, such as a visual representation or other suitable representation, which may be analyzed by a processing system, additive manufacturing system, a user, and/or the like, including combinations and/or multiples thereof.

One or more embodiments are provided for a machine learning platform for additive manufacturing systems. The machine learning platform provides for a user to improve print quality over time using three-dimensional (3D) visualization of process data about the printing process and process corrections from the data and its analysis

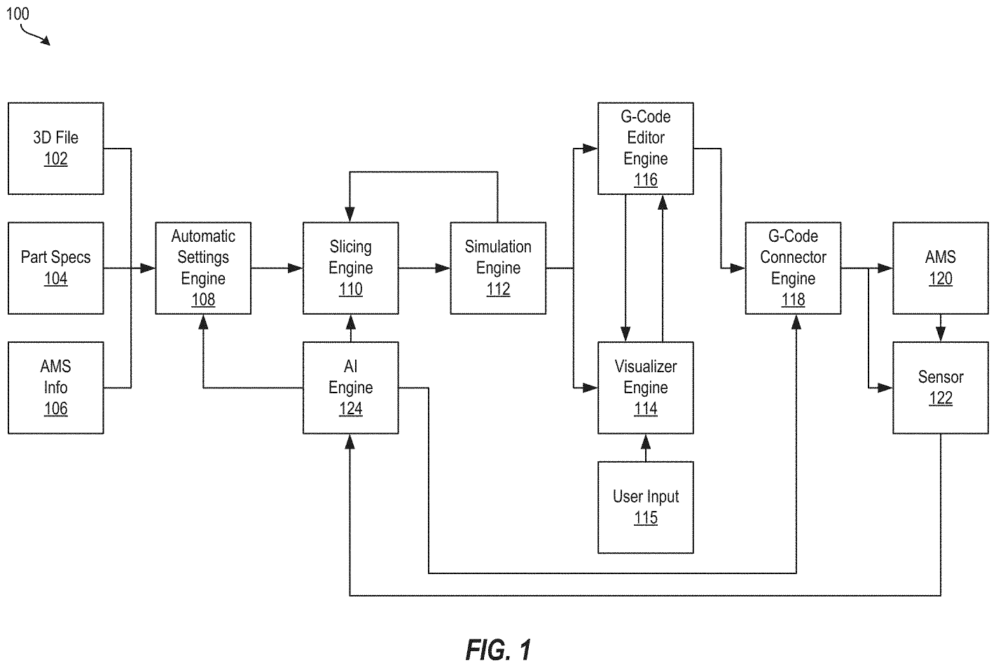

FIG. 1 depicts a block diagram of a system 100 for simulation, correction, and visualization during operation of an additive manufacturing system according to one or more embodiments described herein.

A 3D file 102, part specifications 104, and additive manufacturing system (AMS) information 106 are input into an automatic settings engine 108. The 3D file 102 provides a 3D model of an object to be manufactured. In examples, the 3D file 102 can be a STEP (.step) file; however, the present disclosure is not so limited and other types of 3D files can be used. The part specifications 104 provide information about the object to be manufactured. The part specifications 104 can include a computer aided design (CAD) model, materials information, and/or the like, including combinations and/or multiples thereof. The AMS information 106 provides information about the additive manufacturing system 120 used to fabricate the object. For example, the AMS information 106 can define parameters of the AMS 120, such as the build volume, supported features, supported materials, number and type(s) of sensor(s), and/or the like, including combinations and/or multiples thereof. The automatic settings engine 108 extracts initial settings based on the 3D file 102, the part specifications 104, and the AMS information 106. Examples of initial settings define fabrication speed, part positioning, etc.

The initial settings from the automatic settings engine 108 are input into a slicing engine 110, which uses the initial settings and/or information from the 3D file 102, the part specifications 104, and/or the AMS information 106 to convert the 3D model of the object to be fabrication into a set of slices (layers or non-planar curves) to be manufactured. According to one or more embodiments described herein, the slicing engine 110 also receives the theoretical settings from the AI engine 124, which identifies similar examples that have printed successfully in the past. The slicing engine 110 defines how the object is to be fabricated (e.g., when to move a toolhead, how to move the toolhead, what speed to move the toolhead, etc.). For example, the slicing engine 110 defines a tool path to fabricate the object. As an example, the slicing engine 110 generates a file or instructions that define how the object is to be fabricated, an example of which is geometric code or “g-code.”

Information from the slicing engine 110 is input into a simulation engine 112 that simulates the fabrication process to be taken by the AMS 120 to fabricate the object. Specifically, the simulation engine 112 uses the information from the slicing engine 110 to simulate the 3D printing process using the slices. The simulation engine 112 can predict over heat conditions, over melt conditions, part deformations, and/or the like, including combinations and/or multiples thereof. The simulation engine 112 then suggests corrections to the fabrication process and feeds those results back to the slicing engineer 110 until an acceptable result is found. Results of the simulation are fed into a visualizer engine 114 and g-code editor engine 116 as shown.

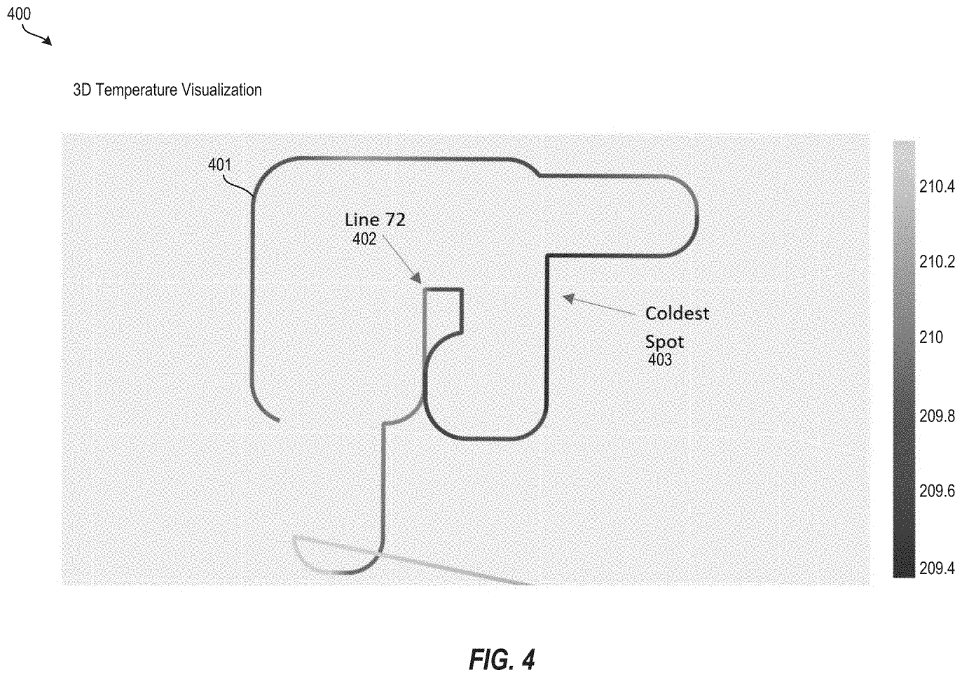

The visualizer engine 114 generates a digital representation of the simulation (simulated fabrication) generated by the simulation engine 112. Examples of digital representations are shown and described in more detail herein (see, e.g., at least FIGS. 4-8, 11, 14, 15, 17, and 20). The g-code editor engine 116 makes changes to improve the 3D printing process determined by the simulation engine 112. For example, the g-code editor engine 116 can edit g-code instructions to reduce undesirable aspects of the simulated fabrication (e.g., to reduce or eliminate over heat conditions, to reduce or eliminate over melt conditions, to reduce or eliminate part deformations, and/or the like, including combinations and/or multiples thereof). Changes from the g-code editor engine 116 can be reflected on the digital representation using the visualizer engine 114. In examples, the visualizer engine 114 can present the digital representation of the simulated fabrication to a user. The user can provide a user input 115 to adjust one or more aspects of the fabrication, and the g-code editor engine 116 can implement those adjustments, which are then visually reflected by the visualizer engine 114 updating the digital representation.

Once adjusted, the g-code is sent from the g-code editor engine 16 to a g-code connector engine 118, which acts as a location for storing the g-code during fabrication of the object. The g-code connector engine 118 sends portions of the g-code to the AMS 120, such as on an as-needed basis. Rather than sending the entire g-code to the AMS 120, sending the g-code in pieces, such as on a slice-by-slice basis or a line-by-line basis, the g-code can be continuously adjusted (if desired) during the fabrication process, and the g-code is then updated in the g-code connector engine 118. This provides for sending the most up-to-date g-code to the AMS 120.

During fabrication, the sensor 122 collects data about the object being fabricated and/or the fabrication process. During fabrication can include real-time (or near-real-time) data collection of the fabrication process. In some examples, fabrication data is collected by the sensor 122 as the object is being fabricated (e.g., as material is being extruded from the toolhead of the AMS 120). In other examples, fabrication data is collected by the sensor 122 while the AMS 120 is stopped (e.g., no material is actively being extruded from the toolhead), such as between two layers of the fabrication process. The sensor 122 can capture, among other information, images and/or data about the object being fabricated. According to one or more embodiments described herein, the sensor 122 can be a time of flight sensor measuring actual material geometry. As another example, the sensor 122 can be a flow rate sensor measuring the material flow rate during the printing process. As yet another example, the sensor 122 can be a contact image sensor, a charge-coupled device (CCD), and/or the like, including combinations and/or multiples thereof. According to one or more embodiments described herein, the scanner 122 can be or can include an infrared (IR) scanner that actively measures temperature of the material as the material is being extruded or deposited and tracks the temperature of the material as the material cools. This provides for making insights into the material's rheology.

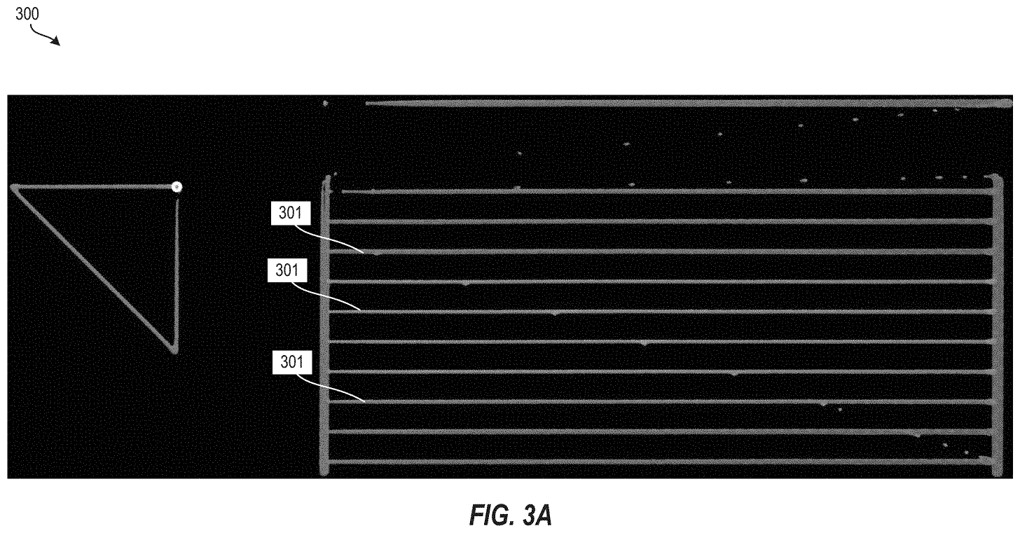

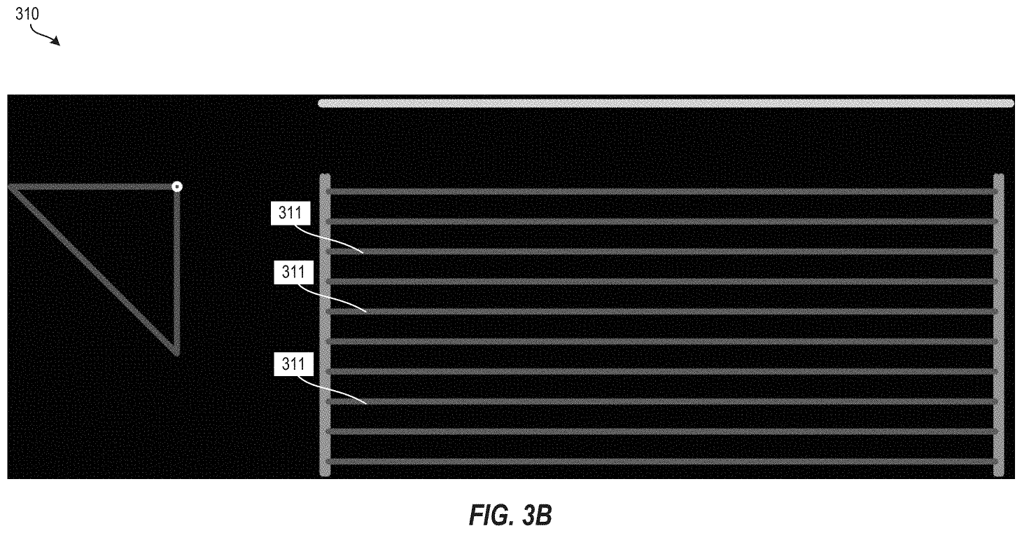

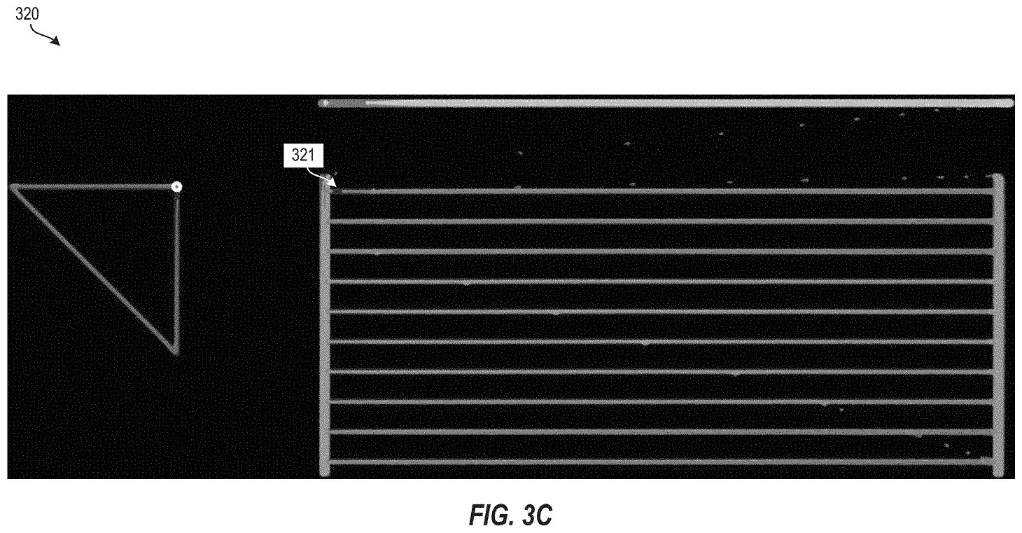

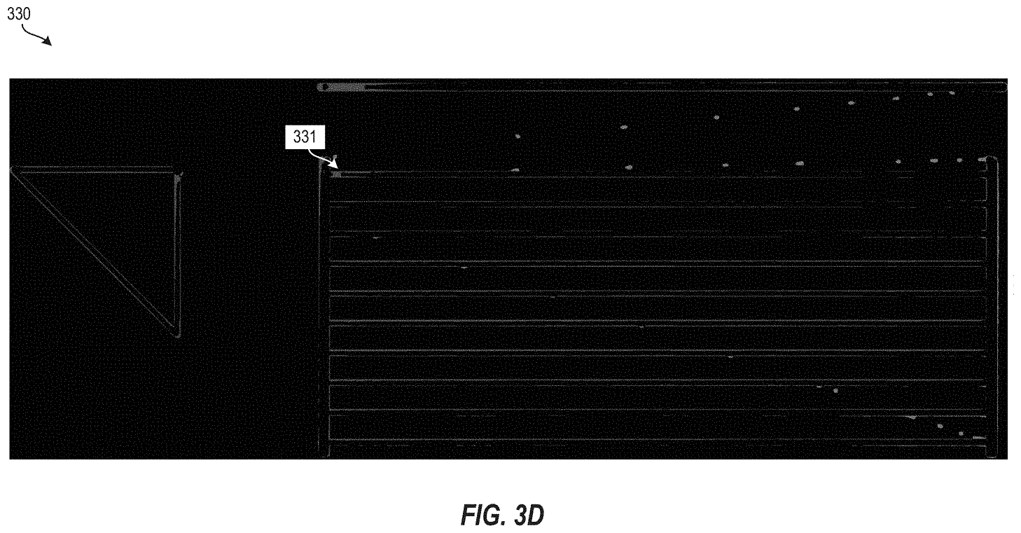

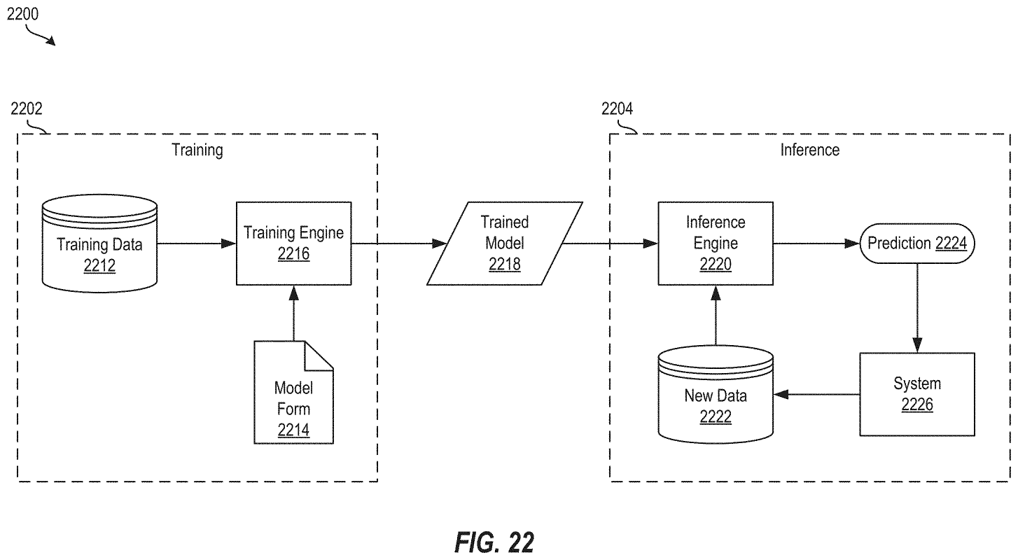

Information (e.g., fabrication data) from the sensor 122 can be fed back to the AMS 120 once it is processed through the AI engine 124 and the g-code connector engine 118 to enable the AMS 120 to make adjustments to aspects of the printing process (e.g., adjust temperature, control the print head, adjust flow rate, etc.). The information from the sensor 122 is fed into an artificial intelligence (AI) engine 124 to provide for to identify potential failure regions and to improve process parameters to avoid failure relating to additive manufacturing. The AI engine 124 maps correlations between inputs (e.g., temperature, speed, etc.) and outputs (e.g., volumetric extrusion). For example, the AI engine 124 can compare an intended output (e.g., from the simulation engine 112) with actual output (e.g., from the sensor 122). FIGS. 3A-3B, described below, show examples of theoretical versus actual output that the AI engine 124 may compare. Further aspects of the AI engine 124 are described herein (see, e.g., discussion of FIG. 22).

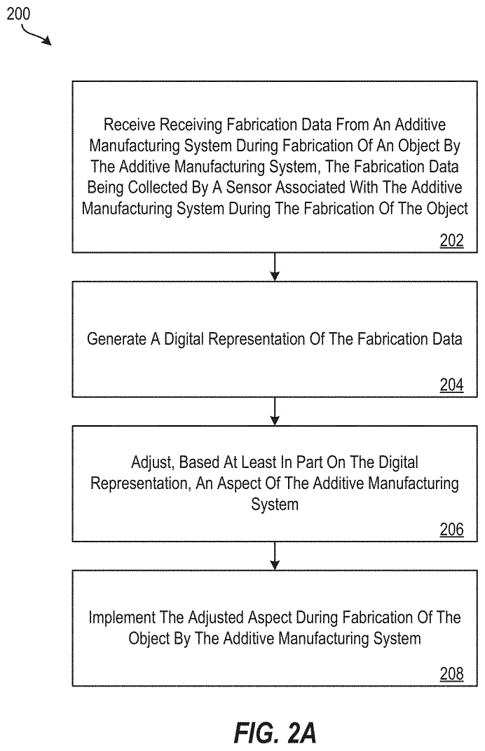

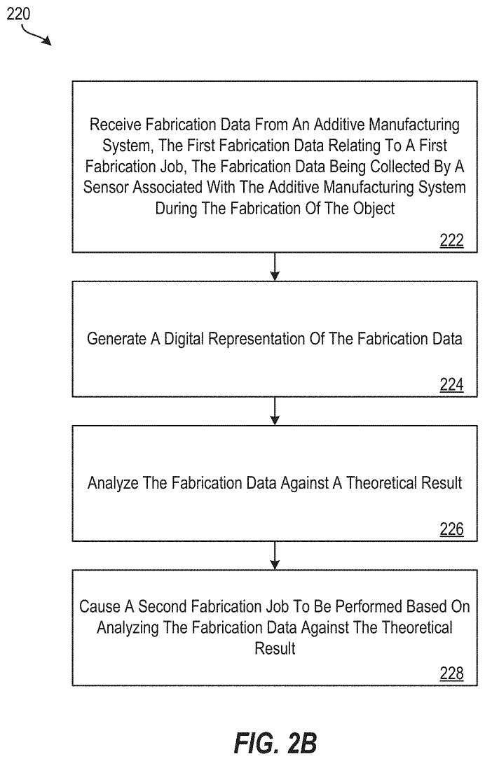

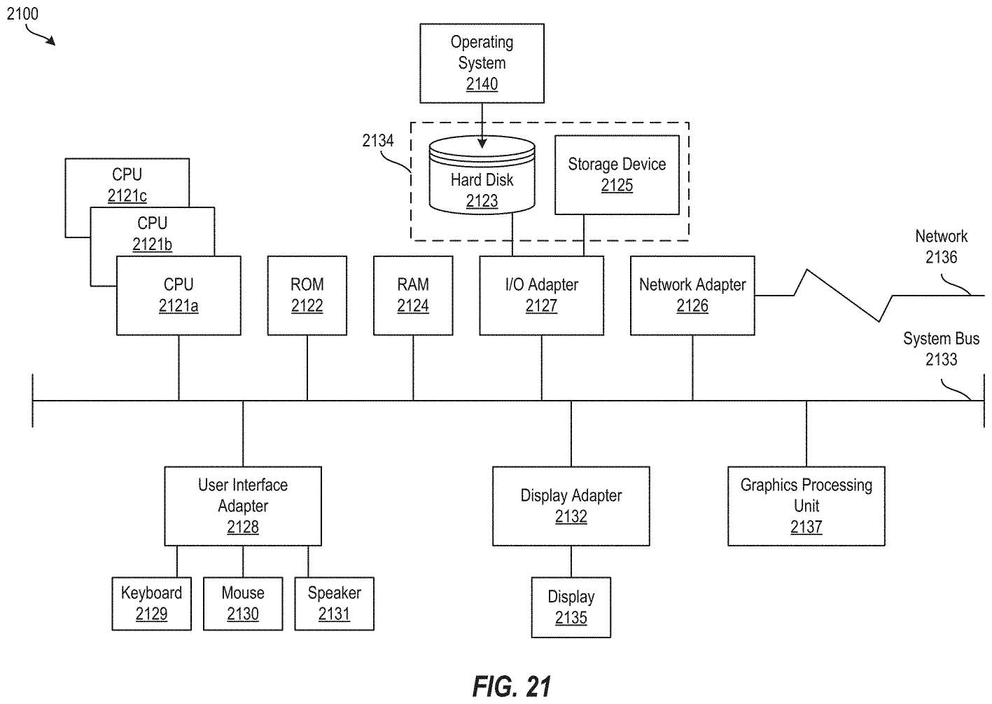

According to one or more embodiments described herein, the system 100 can be implemented using a processing system, such as the processing system 2100 of FIG. 21, described in more detail herein. The various components, modules, engines, etc. described regarding FIG. 1 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), graphics processing units (GPUs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include a processing device (e.g., one or more of the processors 2121 of FIG. 21, etc.) for executing those instructions. Thus a system memory (e.g., the RAM 2124 of FIG. 21, the ROM 2122 of FIG. 21, etc.) can store program instructions that when executed by the processing device implement the engines described herein. Other engines can also be utilized to include other features and functionality described in other examples herein. Features and functionality of the system 100 are now described in more detail with reference to FIGS. 2-20.

FIG. 2A depicts a flow diagram of a method 200 for additive manufacturing according to one or more embodiments described herein. The method 200 can be implemented by the system 100, for example, or by another suitable system, device, and/or the like, including combinations and/or multiples thereof. In examples, the method 200 can be implemented, in full and/or in part, by the processing system 2100.

At block 202, the system 100 receives and/or collects fabrication data from an additive manufacturing system (e.g., the AMS 120) during fabrication of an object by the additive manufacturing system. The fabrication data is collected by a sensor (e.g., the sensor 122) associated with the additive manufacturing system during the fabrication of the object. According to one or more embodiments described herein, the sensor 122 is a contact image sensor (CIS), although other types of sensors can be used as described herein.

At block 204, the system 100 generates a visual representation of the fabrication data. As described herein, the 3D visualizations are made by taking inputs referred to as “key process parameters” (e.g., machine temperature and volumetric extrusion) and pairing key process parameters with a corresponding timestamp and positional data captured by the additive manufacturing system (e.g., the AMS 120), sensors preforming data collection (e.g., the sensor 122), or machine. By doing this, it is possible to create colorful and textured 3D mappings (i.e., visual representations) illustrating the different key process parameters, or set values, over the course of a 3D print. Examples are shown in at least FIGS. 4-8, 11, 14, 15, 17, and 20 and are further described herein.

At block 206, system 100 adjusts, based at least in part on the visual representation, an aspect of the additive manufacturing system. Using visual visualizations of fabrication data (whether simulated or experimental) provides for the continuous improvement of a 3D printing process of an additive manufacturing system and therefore also provides for the correction and continuous improvement of the 3D printed parts being produced as described herein.

At block 208, the system 100 implements the adjusted aspect during fabrication of the object by the additive manufacturing system. For example, proactive measures can be taken to adjust the set values/key process parameters based on the part geometry or feature being printed.

According to one or more embodiments described herein, the fabrication data is collected during the fabrication of a layer of the object. In such cases, the adjusted aspect can be implemented during fabrication of the layer of the object and/or during fabrication of a subsequent (e.g., second) layer of the object.

According to one or more embodiments described herein, the fabrication data is collected after the fabrication of a layer of the object and before the fabrication of a subsequent layer of the object. In such cases, the adjusted aspect can implemented during fabrication of the subsequent layer of the object.

Additional processes also may be included, and it should be understood that the process depicted in FIG. 2A represents an illustration, and that other processes may be added or existing processes may be removed, modified, or rearranged without departing from the scope of the present disclosure.

At block 222, the system 100 receives and/or collects fabrication data from an additive manufacturing system. The fabrication data relates to a first fabrication job. The fabrication data is collected by a sensor associated with the additive manufacturing system during the fabrication of the object. At block 224, the system 100 generates a digital representation of the fabrication data as described herein. At block 226, the system 100 analyzes the fabrication data against a theoretical result. An example of the analysis at block 226 is depicted in FIGS. 3A-3D and is described herein with reference to those figures. At block 228, the system 100 causes a second fabrication job to be performed based on analyzing the fabrication data against the theoretical result, which provides possible improvements as described herein.

Additional processes also may be included, and it should be understood that the process depicted in FIG. 2B represents an illustration, and that other processes may be added or existing processes may be removed, modified, or rearranged without departing from the scope of the present disclosure.

FIG. 3A depicts an example of an image 300 of scan data captured by a sensor (e.g., the sensor 122) associated with an additive manufacturing system for an object being fabricated according to one or more embodiments described herein. The green lines 301 is an image of extruded material for a layer of the printing process. As can be observed, the material varies, such as in depth (as shown by color intensity) and width.

FIG. 3B depicts an example of an image 310 of simulated data of the object being fabricated according to one or more embodiments described herein. The red lines 311 correspond to the green lines 301 of FIG. 3A.

FIG. 3C depicts an example of an image 320 of combined scan data and simulated data from FIGS. 3A and 3B respectively according to one or more embodiments described herein. Differences between the simulated (i.e., expected or theoretical) data of the image 310 and the scan data (i.e., actual data) of the image 300 can be seen in the image 320. For example, the arrow 321 points to an area where the simulated data expected extruded material but no extruded material was deposited. The techniques described herein provide for improving the fabrication process and/or operation of additive manufacturing systems (e.g., the AMS 120) to correct deficiencies such as these using, for example, simulation, correction, and visualization techniques.

FIG. 3D depicts an example of an image 330 generated by machine vision algorithm identifying problem regions by comparing the data from FIGS. 3A and 3B respectively according to one or more embodiments described herein. Particularly, the image 330 depicts the inconsistencies of the real printed part (i.e., actual data) from FIG. 3A when compared to the simulated printed part (i.e., expected or theoretical data) in FIG. 3B according to one or more embodiments described herein. For example, the arrow 331 corresponds with the missing extrusion outlined in arrow 321 of FIG. 3C. The techniques described herein provide for improving the fabrication process and/or operation of additive manufacturing systems (e.g., the AMS 120) to correct deficiencies such as these using, for example, simulation, correction, and visualization techniques.

Three-dimensional visualization of the 3D printing process to improve 3D printing process and 3D parts being printed are now described according to one or more embodiments described herein. According to one or more embodiments described herein, using 3D visualizations of print process data (i.e., fabrication data) (whether simulated or experimental) provides for the continuous improvement of a 3D printing process of an additive manufacturing system and therefore also provides for the continuous improvement of the 3D printed parts being produced.

Specifically, the 3D visualizations are made by taking inputs referred to as “key process parameters” (e.g., machine temperature and volumetric extrusion) and pairing each of these key process parameters with a corresponding timestamp and positional data captured by the additive manufacturing system or machine. By doing this, it is possible to create colorful and textured 3D mappings illustrating the different key process parameters, or set values, over the course of a 3D print.

Furthermore, after 3D visualizations of any and all parameters that could have a material effect on the printing process or the printed part are rendered, the next process step is capturing 2D images of each of the 3D process mappings, and feeding those 2D images into a machine learning model such as a convolutional neural net (CNN).

The key process parameters that are pictured in 2D, from the 3D mappings, are then checked against actual print-result data captured by on-board sensors of the additive manufacturing system, whether on axis or off axis. The on board sensors collect information on the output or result of the machine process. Examples of such sensors include a time of flight sensor measuring actual material geometry or a flow rate sensor measuring the material flow rate during the printing process.

By evaluating how the key process parameters being visualized compared to the actual collected data from on board sensors, patterns, correlations, and causations can be recognized that uncover how the set values (or key process parameters) relate to the expected output value of a 3D printer. The benefit of collecting data from on board sensors is the ability to compare the actual part geometry to the theoretical 3D computer file to cross reference as a gauge of accuracy. This comparison can be used to better understand how set values effect final part quality and geometric dimensioning and tolerancing.

After gaining this knowledge of how machine inputs (set values and key parameters) affect machine outputs (geometry, accuracy of material extrusion), tools are provided for users to accurately predict, before the 3D printing process, the location, probability, and root cause of a print failure, defect, or anomaly. Additionally, users are provided with the novel ability to take corrective action before a print is started, based on the simulated potential process errors that are flagged using our software. For example, thermal energy per unit area can be calculated and plotted in 3D, by using the nozzle hot end temperature, the printer motion speed or velocity, and the fan power (including other methods of cooling local or ambient temperature) in a given region or set of coordinates. If a certain feature of a part being 3D printed includes unique geometry, and that unique geometry then causes thermal energy to rise above its acceptable bounds, the associated error region can be visualized and the user is provided tools for both manual and automated solutions. Similarly, if a certain feature includes long sweeping lines, the printer's thermal energy can be reduced as a result of increased heat transfer from the hot end/nozzle to the material being extruded. In this scenario, proactive measures could be taken, manually or automatically, that adjust the set values/key process parameters based on the part geometry or feature being printed.

The next step beyond predictive pre-processing for additive manufacturing is real time feedback happening live during the printing process, which is enabled by the system 100 of FIG. 1. Instead of having to simulate a part build to flag potential hazard areas that will likely cause print failures/defects, one or more embodiments described herein provide for compute speeds sufficient enough for real time (or near real time) feedback, where instead of a user action being taken during the predictive pre-processing stage prior to a print, adjustments and corrections can be made (automatically and/or manually) during the printing process. Eventually, with enough training data, supervised and unsupervised learning paired with physics based simulations, a set of instructions for 3D printing any given part, on any given printer, can be created without the need for human intervention past the point of a complete 3D model produced in any common CAD software.

This approach is beneficial because by using 3D visualizations and 2D images, complex sets of information are simplified and these computationally intensive data sets are transformed into more efficient and compressed forms of data structures so that they can be processed at much higher speeds and with less compute power respectively.

Advantages of one or more embodiments described herein are as follows, but are not so limited: The ability to 3D print at higher speeds; The ability to 3D print more complex geometries more accurately and reliably; The ability to print previously impossible geometries; Less time required by users to set up 3D prints; More accurate 3D printing; More reliable 3D printing; A greater reach of effectiveness due to the lowered barrier of entry (professional education/expert knowledge currently required); Improved predictive maintenance for machines due to the constant collection and monitoring of printer performance; Reduced time for part verification, instead of the additional scanning that's required to verify part geometry today, in process sensors and monitoring could provide that faster and more efficiently; Reduced time to release new manufacturing materials to the market as all the information required for material testing can be collected faster and more efficiently with in process sensors and monitoring; Reduced machine downtime as a result of constant machine monitoring along with more predictable and reliable printer performance; Savings in material cost (e.g., less 3D print failures and more successful parts results in less material waste); More effective amortization of machines (e.g., with higher print success rates, and machines being amortized over its lifetime and the number of parts printed during that lifetime, an increase in successfully printed parts can help reduce machine running costs per hour).

Three-dimensional visualization of the 3D printing process to determine functional properties and performance is now described according to one or more embodiments described herein. According to one or more embodiments described herein, 3D visualizations of the 3D printing process (whether simulated or experimental) are provided to determine, for any given 3D printed part, its functional properties (e.g., fatigue life, tensile strength, etc.) and performance in a real world application.

By monitoring and measuring how material is melted and formed during the additive manufacturing process, in combination with looking at positional data relative to the prior layer, among other data points, the process can be visualized in 3D (e.g., using the simulation engine 112 and visualizer engine 114) and determinations can be made about a part's properties.

The 3D visualization of the additive manufacturing process may be used as an input for other available simulation software, or it could be loaded into an internal and independent simulation software developed in conjunction with one or more of the embodiments described herein.

The benefits of using 3D visualizations to represent 3D printing process data for the purpose of determining a parts properties and performance under a given load case or otherwise any real world application are as follows but are not so limited: More time efficient than the current alternative of destructive testing of parts; A greater ability to hold digital inventory (more efficient use of physical space) and printing at the point of need (only possible with the ability to 3D print a part whose properties are highly predictable; More materials and design considerations are possible given faster iteration cycles for strength testing; A greater capacity for standards and certifications to increase safety of final parts used for critical life saving applications; The ability to better understand why failures are occurring and how to resolve them; The process being proposed will require a combination of physics based simulation as well as physical destructive testing of parts and different materials.

Application components and flow are now described according to one or more embodiments described herein. According to one or more embodiments described herein, a process is provided that includes: performing data acquisition, performing data alignment and cleaning, preforming an initial print data analysis, performing figure generation, performing image generation, performing machine learning, performing figure regeneration, performing pre-processing, preforming real-time control, performing part property detection, and performing part property pre-processing. This process can be implemented, for example, using the system 100 of FIG. 1 or another suitable system.

Data Acquisition: The data processed can include the coordinates (e.g., cartesian, polar, etc.) of the printer's effector and one further value to map against position and time. This data can be presented in the form of logs from the additive manufacturing machine itself or are a set of combined data streams from the machine, during the printing process.

Data Alignment and Cleaning: Since, in some examples, the log or combined streams may not be clean and/or regular enough for effective application use, a parsing step can be performed where the streams are broken down into their component parts and then re-assembled into a normalized structure for further analysis. Captured data inputs (columns) include but are not limited to x-position, y-position, z-position, e-position, measured hotend temperature, hotend set temperature, tool ID, bed temperature, measured bed temperature, environmental temperature, set environmental temperature, air humidity, filament moisture content, measured filament diameter, extrusion rate, motion speed, flow rate, filament pressure, nozzle force, nozzle pressure, axis velocity, axis acceleration, axis vibration, laser sensed distance, extrusion line diameter, extrusion line height, extrusion line side wall interactions, extrusion line curvature, extrusion line thermal energy, extrusion line internal force, extrusion line thermal image, axis motor current, filament material type, current line type, and current feature type.

Initial Print Data Analysis: Simple patterns get flagged and basic mathematical calculations occur. Examples of these patterns and calculations include range, average, variance, minimum, maximum, as well as signal processing like fourier transforms to discover cyclic timings. Additionally, each column is checked in order to verify that the values do not exceeded a given tolerance zone.

Figure Generation: The clean and analyzed process data is then mapped into a 3D line graph where the x y, and z positional data is mapped sequentially with line segments connecting each point. The color and size of the line can be modified by the other variables individually and/or in combination. The generated is useful for user understanding of an extremely complex system.

Image Generation: 2D layer and 3D part images are generated from the 3D line graph by cutting and viewing with different slice types and perspective angles. This set of images creates a simplified data structure to use in order to train a machine learning model.

Machine Learning (training): Using the images generated, a machine learning model digests the images and finds patterns that relate potential errors, potential future errors, failure modes, and final part properties with the collected sensor data as represented by the images in combination. In some examples, the machine learning model executes on a graphics processing unit or an edge processing device.

Figure Regeneration: The 3D line graph is regenerated and marked using any new data and patterns created by the machine learning model.

Pre-Processor: A G-code preprocessor digests a G-code document and looks for and identifies potential errors, failure modes, and theoretical print properties. As more lessons are learned through machine learning, those lessons are fed into the preprocessor to better identify the prior listed items.

Real-Time Control: Real-time (or near real time) control feedback is used to modify the G-code as well as the current and future states of the print and printer in order to prevent failures from occurring and/or to improve final part properties like strength. In one or more embodiments, the controller uses the lessons learned from the machine learning, information presented from the preprocessor, live sensor readings, and/or how all those relate together to reduce the likelihood of failure or errors. In one or more examples, correcting for regional distortions and variables to salvage a potential issue is possible.

Part Property Detection: By using the sensor data collected during the print, another machine learning model, using the same data structures and data sets, can identify, flag final, and describe part properties like layer adhesion, internal stresses, gaps and voids, and more in order to verify that a part meets its use requirements. When handling multi-process or multi-material prints, the binding and adhesion between materials and process segments can also be identified, flagged, and described.

Part Property Pre-Processor: The output of the part property detection machine learning model is fed back into the preprocessor in order to describe a part's theoretical final properties, verify that they meet use requirements, and then modify the G-code such that the final part is optimized and meets all requirements.

Some of the technical advantages of one or more embodiments described herein are as follows. In-situ part property verification that removes the need for secondary inspection and paves the way for part certification. Cross-machine and cross-part standardization enables a manufacturer to verify that two parts off the same or different machines with the same or different feedstock are functionally comparable to each other. This is done by identifying and correcting for each machine's (and its subsequent and tangential systems') “personalities.” Real-time (or near real time) control from deeper and more detailed information allows machines to be run at the upper edge of their capabilities and maximizes their output, value, and experimentation potential. Enables printers to operate in harsher and more variable environments like ships on rough waters as corrective and pre-emptive actions can be implemented in real-time or near real-time.

Application components and flow are now described according to one or more embodiments described herein. According to one or more embodiments described herein, a process includes performing data acquisition, performing data alignment and cleaning, performing initial print data analysis, and performing figure generation. Such a process can identify patterns and problems related to temperature in 3D space. In this example, the color can be switched out for other currently measured variables including but not limited to and not shown below like volumetric extrusion, volumetric extrusion rate, extruder motor current, motion speed, motion time, heat energy per unit area, changes, rate of change of speed, rate of change of extrusion, rate of change of extrusion volume and rate of change of extrusion rate.

FIG. 4 depicts a 3D temperature visualization 400 of a first layer of an object being fabricated according to one or more embodiments described herein. In the example of FIG. 4, a first layer visualization 401 in 3D as viewed from the top is shown. As can be observed, the temperature varies from line to line (e.g., line 72 402) as the print is executed. In this example, the print failed very early due to the area marked “Coldest Spot” 403 peeled off the print surface.

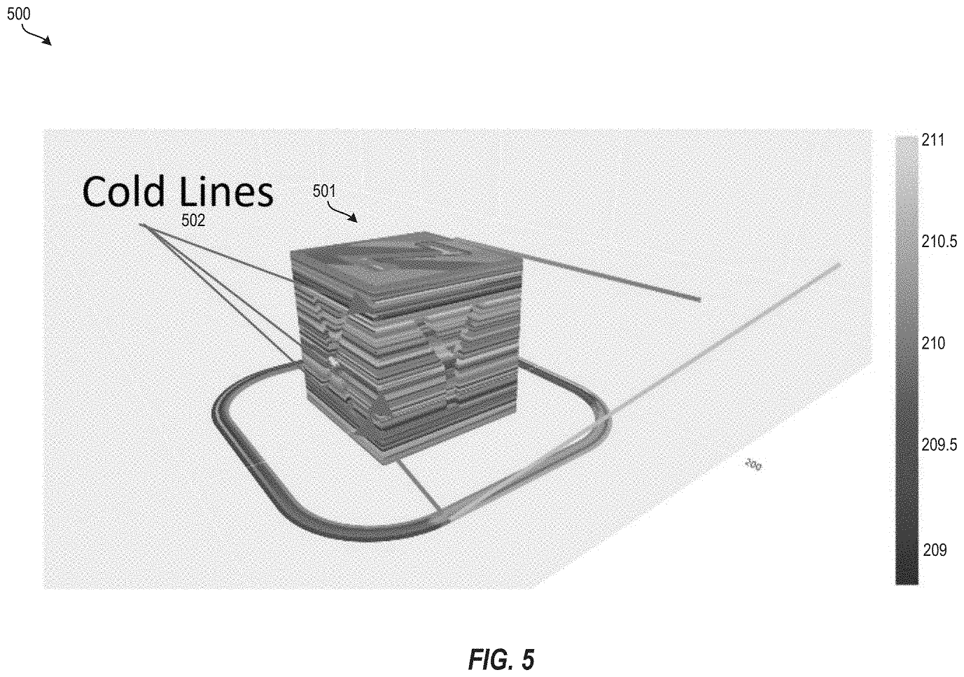

FIG. 5 depicts a 3D temperature visualization 500 of an object being fabricated according to one or more embodiments described herein. In the example of FIG. 5, a calibration cube 501 is being printed. It can be observed that, on the exterior sides (marked) as well as on the top surface and brim (unmarked) contain very dark purple-blue lines (“cold lines”) indicating colder temperatures (e.g., cold lines 502) and then hotter yellow lines (unmarked) that represent hotter temperatures. These heat differences lead to differing volumes of plastic being extruded due to viscosity changes as well as changes in surface quality, layer strength, and overhang quality among other things.

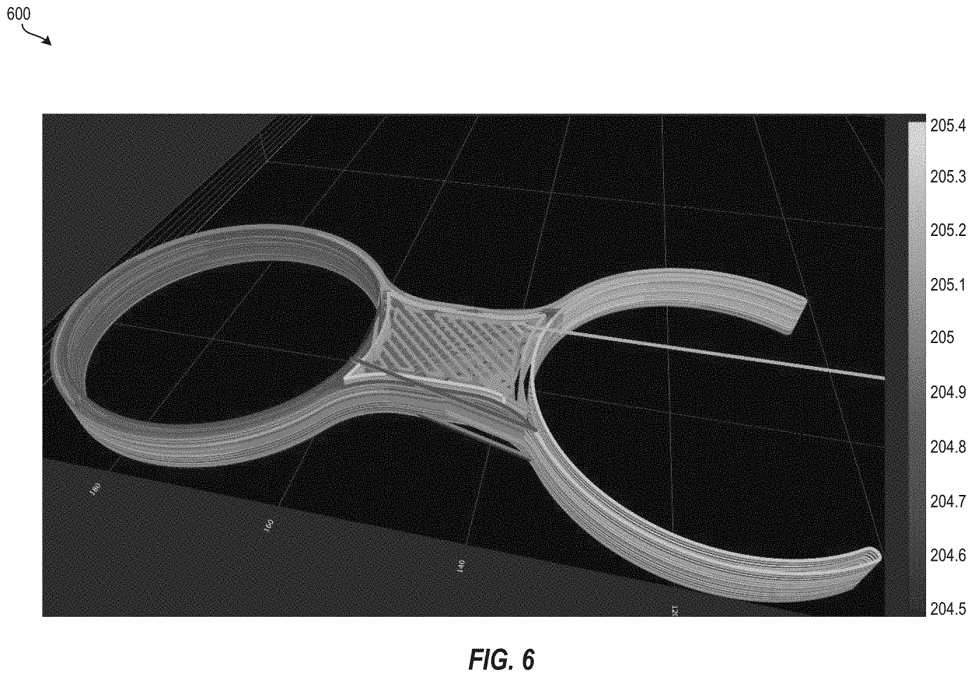

FIG. 6 depicts a part 600 being fabricated according to one or more embodiments described herein. In the example of FIG. 6, it can be observed that the right half (darker pinks and purples) of the part is hotter than the left (lighter pinks and yellows). This part had perimeter separations on the left, but not the right, indicating that the temperature in a region affected that characteristic. This also indicates that the print environment was uneven.

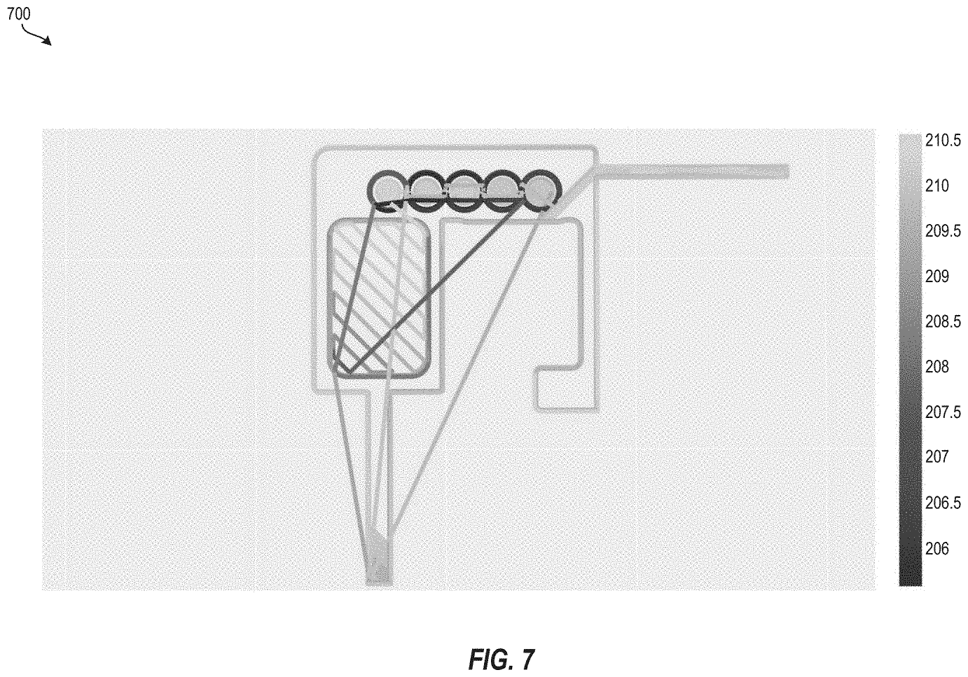

FIG. 7 depicts a top down view 700 of a 3D part being fabricated according to one or more embodiments described herein.

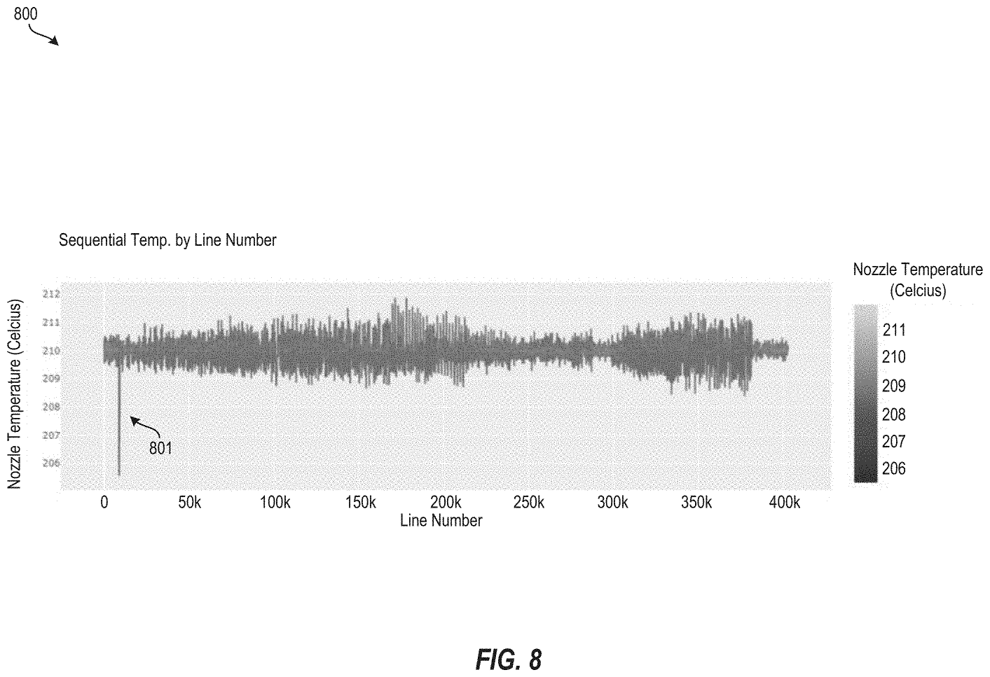

FIG. 8 depicts a sequential temperature by line number graph 800 associated with FIG. 7 according to one or more embodiments described herein.

In the example of FIGS. 7 and 8, top down view 700 of the 3D part is restricted to the area around the dip 801 in the time series data contained in the sequential temperature by line number graph shown in FIG. 8. Here, it can be observed that a significant and sudden drop (e.g., the dip 801) in temperature around line 8K (see FIG. 8) occurs while the part is printing a high tolerance perimeter as is shown by the dark purple circles (see FIG. 7). That temperature drop drastically reduces the flow and changes the final geometry of the extrusion line causing a possible error in both part properties and critical dimensions.

Artificial intelligence (AI) optimization and AI application are now described according to one or more embodiments described herein. One or more embodiments described herein can implement AI techniques, such as using the AI engine 124 of FIG. 1 and/or the machine learning training and inference system 2200 of FIG. 22. According to one or more embodiments described herein, 3D image generation can be used to train a machine learning model (artificial intelligence) to identify potential failure regions and to improve process parameters to avoid failure. To do this, one or more embodiments apply a convolutional neural network (CNN) on the process data received from additive manufacturing systems (e.g., the AMS 120). The one or more embodiments can also apply a generative adversarial network (GAN) on the process data of the additive manufacturing systems (e.g., the AMS 120). When training AI, this could accelerate one or more of the processes described herein substantially, allowing for improvements on the epoch time as well as improving input bandwidth. Using image base training is an effective way to identify features and issues in 3D space and can outperform other models that do not work with image data.

According to one or more embodiments described herein, 3D image generation can be used to compress the large files in 3D printing. Conventionally, data is stored in uncompressed or traditionally compressed numerical matrices. With the data collected from a single print reaching gigabytes of information, this is unsustainable for effective process data capture. The present techniques address these and other shortcomings of the prior art by converting these numerical matrices into 3D images. By doing so, process information can be stored in a file format that compresses the information (in some cases, exponentially). These images can be utilized to recreate the numerical matrices by using 2D to 3D mapping algorithms. This can be useful for applications that require storage of process information for compliance, thereby reducing the amount of storage issues this could create. This can also be useful for storing 3D printer data analysis, which is expensive due to the data storage issue. By compressing this information, this information can be more readily available to be used to improve and inform manufacturing processes.

According to one or more embodiments described herein, the 3D printing process data can be used to identify the physical properties of a 3D printed part. Conventionally, simulation or destructive testing is the only way to know what properties an additively manufactured part will have. The present techniques address these and other shortcomings of the prior art by using in-process data to simulate (e.g., using the simulation engine 112) the expected part properties and variations caused by the process itself. This is useful because it allows for the part properties to be identified more accurately then simulation, allowing for additive manufacturing to operate in more mission critical and end use applications. It also allows for process variations to be evaluated on multiple parts and to improve safety and performance, such as on parts that comes from a machine with this technology. An example of a system for implementing artificial intelligence according to one or more embodiments described herein is shown in FIG. 22 and is described further herein. One or more aspects of artificial intelligence described herein can be implemented in the AI engine 124 of FIG. 1, independently and/or in combination with one or more of the features or components of the machine learning training and inference system 2200 of FIG. 22.

An example of a temperature log analysis is now described according to one or more embodiments described herein. First, an analysis/calibration cube is described, then two bench mark tests are described, one failed and one passed.

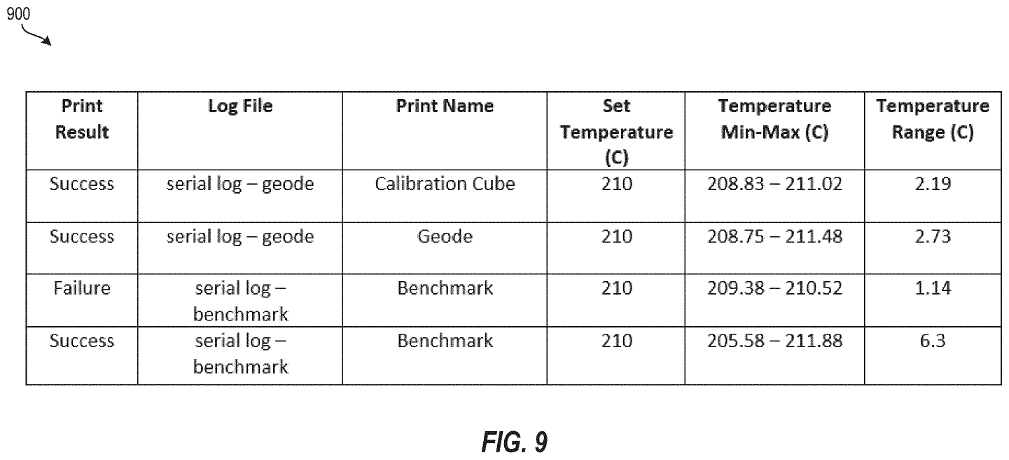

FIG. 9 depicts a table 900 of results of the analysis at a glance according to one or more embodiments described herein.

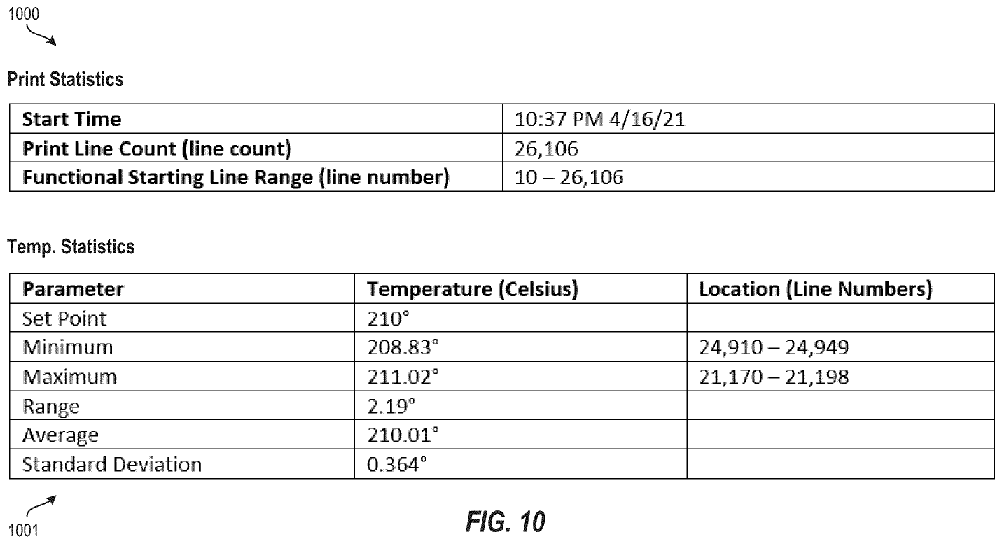

The analysis/calibration cube is now described. FIG. 10 depicts a table 1000 of print statistics and a table 1001 of temperature statistics according to one or more embodiments described herein.

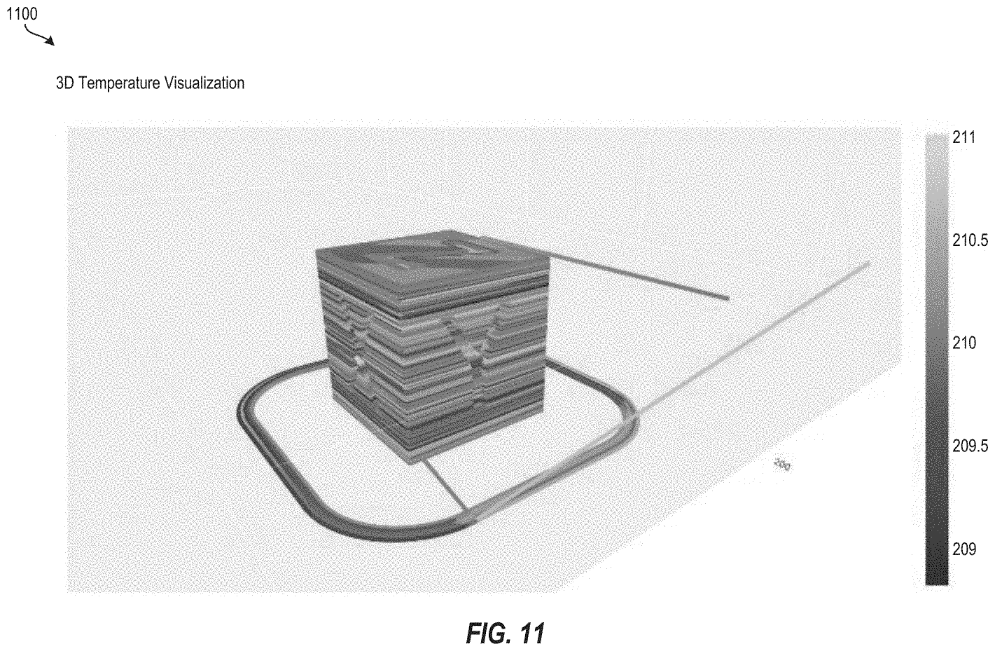

FIG. 11 depicts a calibration cube 3D temperature visualization 1100 according to one or more embodiments described herein.

It is evident from FIG. 11 that at least on the perimeter layers of the cube, there was significant variation where at least 3 external perimeters printed cold at around −1 degrees Celsius (see purple) below a setpoint. Additionally, there were some warmer lines as shown (see bright yellow) at about +1 degrees Celsius above the setpoint. As can be seen, many of the lines and layers have a different temperature as shown by the sporadic temperature swings.

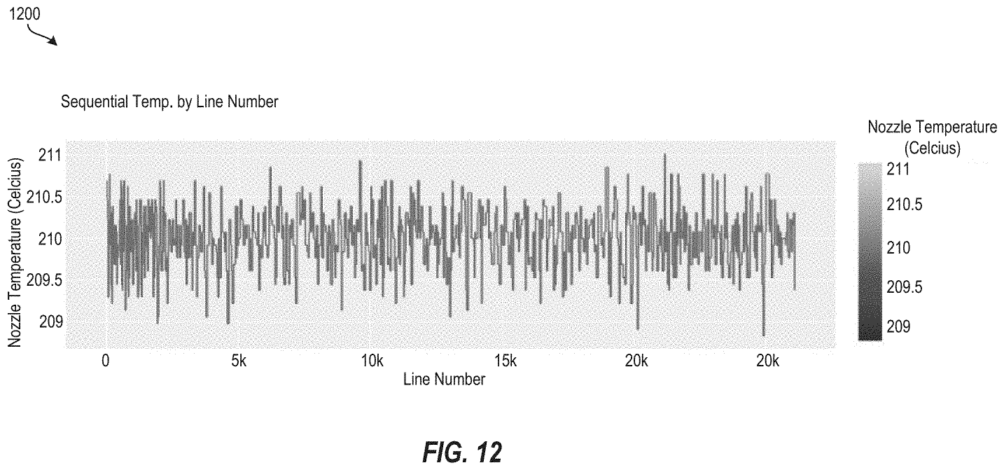

FIG. 12 depicts a sequential temperature by line number graph 1200 associated with FIG. 11 according to one or more embodiments described herein.

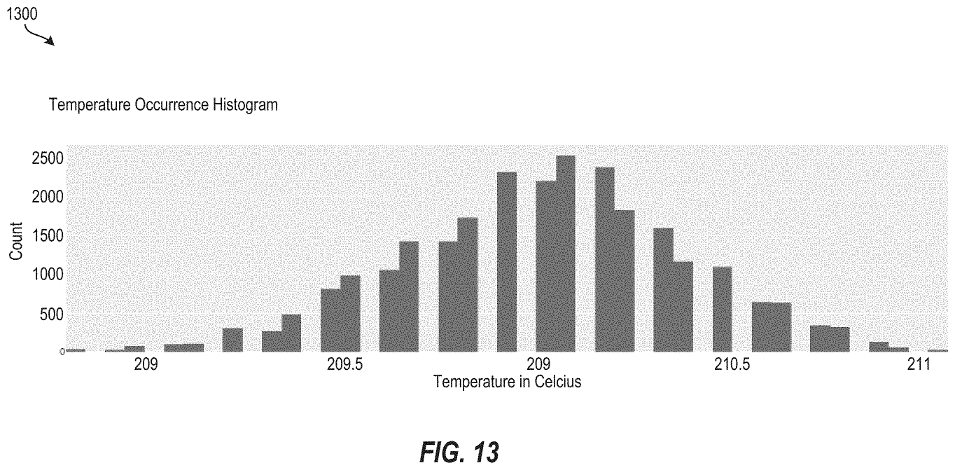

FIG. 13 depicts a temperature occurrence histogram in degrees Celsius for the calibration cube 3D temperature visualization 1100 of FIG. 11 according to one or more embodiments described herein.

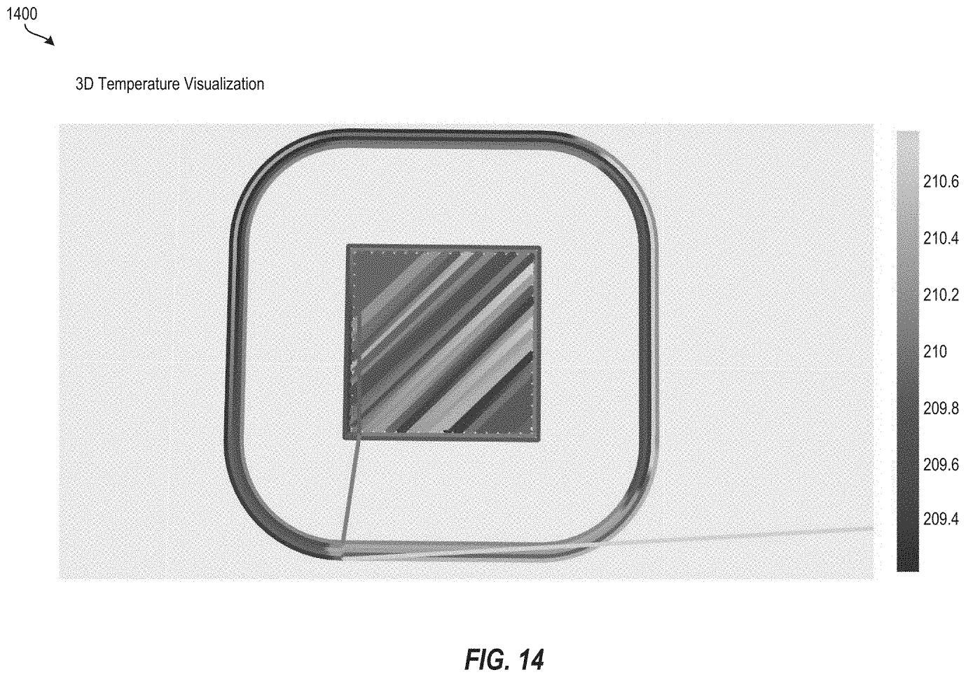

An analysis is performed on the calibration cube 3D temperature visualization of FIG. 11 according to one or more embodiments described herein. Particularly, FIG. 14 depicts 3D temperature visualization 1400 of a first layer of the calibration cube of FIG. 11 according to one or more embodiments described herein.

The first layer of this print, as shown in FIG. 12, is highly variable and may be prone to delamination or unrecoverable failure as a result of the changing temperatures during the layer. As shown in FIG. 14, the first layer ranges from about 209 degrees Celsius to about 210.8 degrees Celsius. The conditions shown in the upper left of the brim shown in FIG. 14 may lead to peeling. Additionally, temperature variations in the infill of the first layer could have poor bed adhesion in both the too hot and too cold regions.

Two benchmark analyses are now described: first, a failed benchmark and second, a successful benchmark.

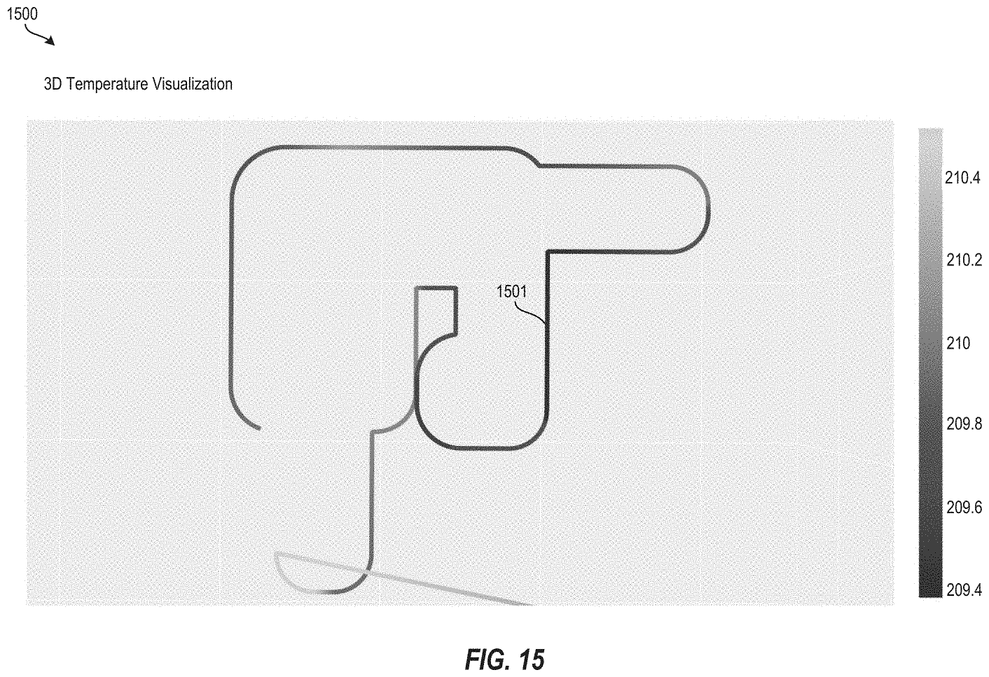

FIG. 15 depicts 3D temperature visualization 1500 of a failed benchmark layer according to one or more embodiments described herein. This print was canceled within the first brim being printed. In FIG. 15, it is evident that the extrusion starting out at around 210.4 degrees Celsius, quickly cooling to 209.9 degrees Celsius, then at line 72 1501, the temperature cools to 209.38 degrees Celsius as at the coldest. In such cases, the brim could separate at one of the corners in the cold region. Additionally, the extrusion was colder around other corners as well, which risk separation.

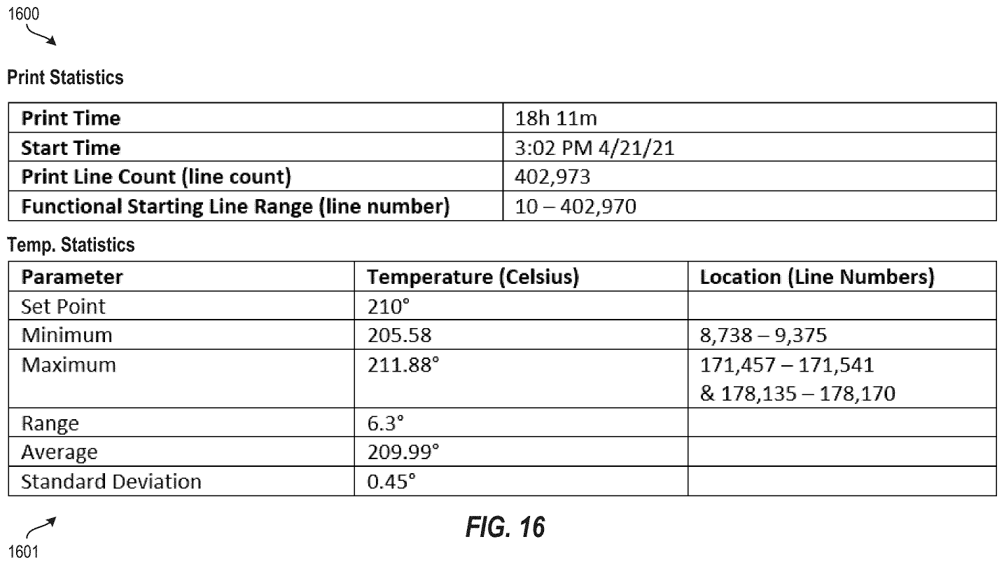

A successful benchmark is now described. FIG. 16 depicts a table 1600 of print statistics and a table 1601 of temperature statistics according to one or more embodiments described herein.

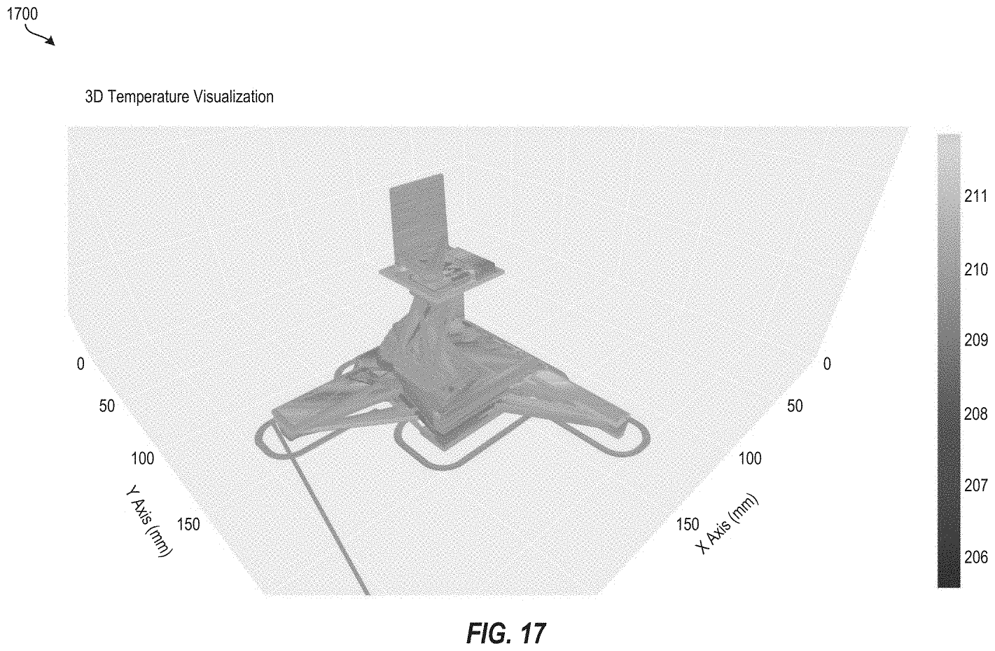

FIG. 17 depicts a calibration cube 3D temperature visualization 1700 according to one or more embodiments described herein.

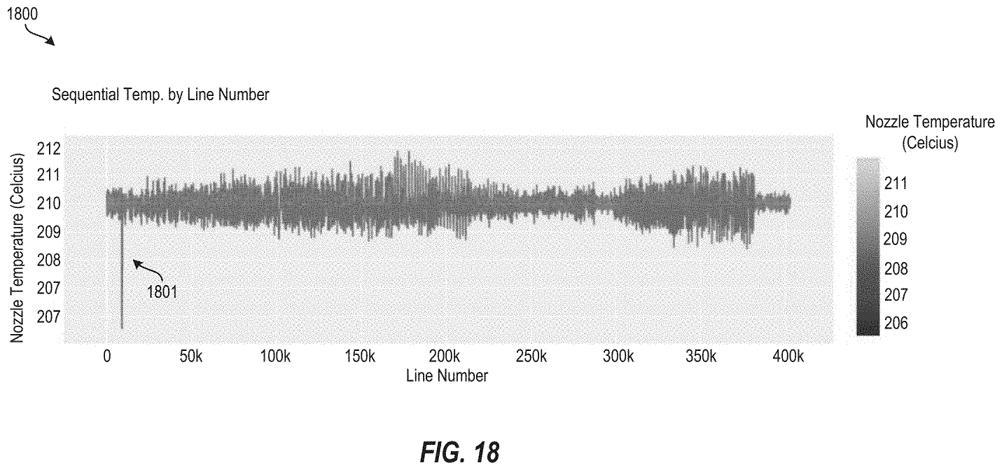

In this example, the print seems stable. However, taking a deeper look at the temperature data of the sequential temperature by line number graph 1800 in FIG. 18, it is apparent that the temperature is both extremely variable and feature dependent. Particularly, FIG. 18 depicts a sequential temperature by line number graph 1800 for the calibration cube 3D temperature visualization 1700 of FIG. 17 according to one or more embodiments described herein.

As is evident from FIG. 18, a sudden temperature drop 1801 from the set point at about 210 degrees Celsius to the minimum of 205.58 degrees Celsius occurred for about 600 lines. A critical region analysis (described further herein) takes a closer look at that section. Otherwise, there is an evident pattern that emerges where the temperature fluctuates more when there are more motions. The section ranging from about line number 225K to about 300K is the vertical column feature in the model. With a more constrained physical area and less variability in hotend velocity due to very few and short travel moves, the temperature is significantly more stable in this region. Similarly in the end, starting at about line 375K, the stringing test feature starts which has high movement, but very short extrusion cycles. Between these two feature types, it is evident that the hotend can stabilize in different setting as long as the thermal dissipation is more constant.

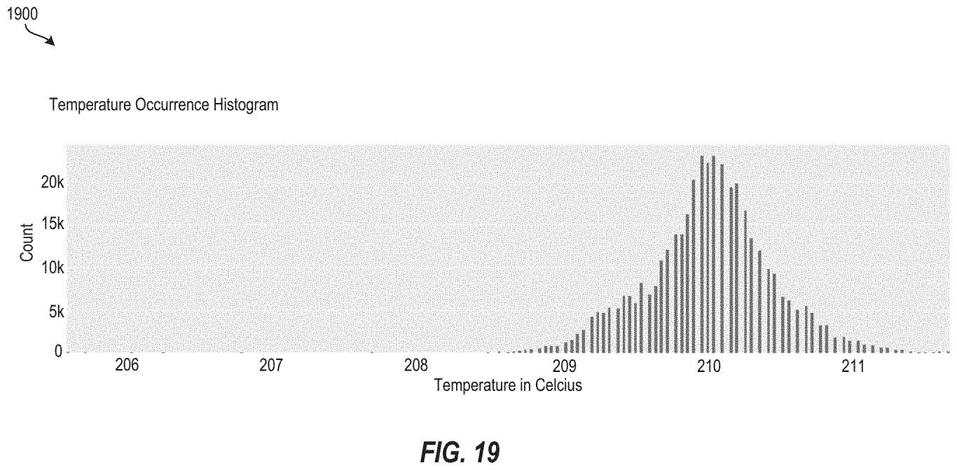

FIG. 19 depicts a temperature occurrence histogram 1900 for the calibration cube 3D temperature visualization 1700 of FIG. 17 according to one or more embodiments described herein.

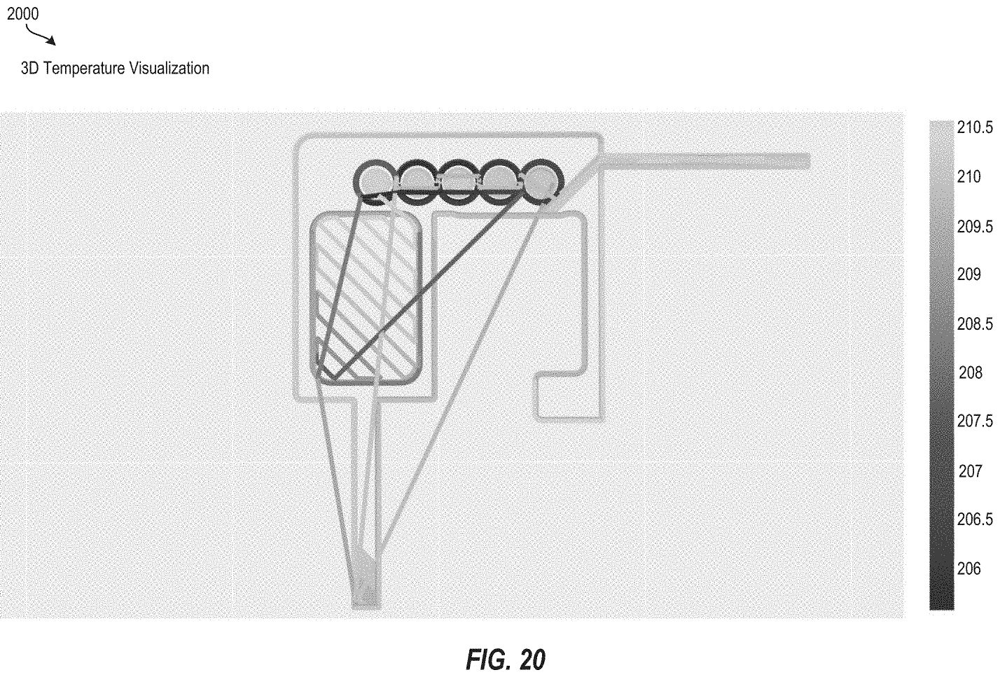

The critical region analysis is now discussed. FIG. 20 depicts a benchmark critical region 3D temperature visualization 2000 for the calibration cube 3D temperature visualization 1700 of FIG. 17 according to one or more embodiments described herein.

FIG. 20 shows an analysis of what happened from line 8000 to 13000, which includes the minimum temperature region. As shown, the minimum temperature perpetuates for about 600 lines: all perimeters testing tolerance. Temperature makes a major difference on the final geometry and volume of any given extrusion. With that, the tolerance test that this benchmark creates will be faulty as this section was far enough outside the temperature tolerance zone to change the material flow.

It is understood that one or more embodiments described herein is capable of being implemented in conjunction with any other type of computing environment now known or later developed. For example, FIG. 21 depicts a block diagram of a processing system 2100 for implementing the techniques described herein. In accordance with one or more embodiments described herein, the processing system 2100 is an example of a cloud computing node of a cloud computing environment. In examples, processing system 2100 has one or more central processing units (“processors” or “processing resources” or “processing devices”) 2121a, 2121b, 2121c, etc. (collectively or generically referred to as processor(s) 2121 and/or as processing device(s)). In aspects of the present disclosure, each processor 2121 can include a reduced instruction set computer (RISC) microprocessor. Processors 2121 are coupled to system memory (e.g., random access memory (RAM) 2124) and various other components via a system bus 2133. Read only memory (ROM) 2122 is coupled to system bus 2133 and may include a basic input/output system (BIOS), which controls certain basic functions of processing system 2100.

Further depicted are an input/output (I/O) adapter 2127 and a network adapter 2126 coupled to system bus 2133. I/O adapter 2127 may be a small computer system interface (SCSI) adapter that communicates with a hard disk 2123 and/or a storage device 2125 or any other similar component. I/O adapter 2127, hard disk 2123, and storage device 2125 are collectively referred to herein as mass storage 2134. Operating system 2140 for execution on processing system 2100 may be stored in mass storage 2134. The network adapter 2126 interconnects system bus 2133 with an outside network 2136 enabling processing system 2100 to communicate with other such systems.

A display 2135 (e.g., a display monitor) is connected to system bus 2133 by display adapter 2132, which may include a graphics adapter to improve the performance of graphics intensive applications and a video controller. In one aspect of the present disclosure, adapters 2126, 2127, and/or 2132 may be connected to one or more I/O busses that are connected to system bus 2133 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 2133 via user interface adapter 2128 and display adapter 2132. A keyboard 2129, mouse 2130, and speaker 2131 may be interconnected to system bus 2133 via user interface adapter 2128, which may include, for example, a Super I/O chip integrating multiple device adapters into a single integrated circuit.

In some aspects of the present disclosure, processing system 2100 includes a graphics processing unit 2137. Graphics processing unit 2137 is a specialized electronic circuit designed to manipulate and alter memory to accelerate the creation of images in a frame buffer intended for output to a display. In general, graphics processing unit 2137 is very efficient at manipulating computer graphics and image processing, and has a highly parallel structure that makes it more effective than general-purpose CPUs for algorithms where processing of large blocks of data is done in parallel.

Thus, as configured herein, processing system 2100 includes processing capability in the form of processors 2121, storage capability including system memory (e.g., RAM 2124), and mass storage 2134, input means such as keyboard 2129 and mouse 2130, and output capability including speaker 2131 and display 2135. In some aspects of the present disclosure, a portion of system memory (e.g., RAM 2124) and mass storage 2134 collectively store the operating system 2140 to coordinate the functions of the various components shown in processing system 2100.

One or more embodiments described herein can utilize machine learning techniques to perform tasks, such as to identify potential failure regions and to improve process parameters to avoid failure relating to additive manufacturing. More specifically, one or more embodiments described herein can incorporate and utilize rule-based decision making and artificial intelligence (AI) reasoning to accomplish the various operations described herein, namely to identify potential failure regions and to improve process parameters to avoid failure relating to additive manufacturing. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used to identify potential failure regions and to improve process parameters to avoid failure relating to additive manufacturing, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. CNNs are a class of deep, feed-forward ANNs that are particularly useful at tasks such as, but not limited to analyzing visual imagery and pattern identification.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of identifying potential failure regions and improving process parameters to avoid failure relating to additive manufacturing as described herein.

Systems for training and using a machine learning model are now described in more detail with reference to FIG. 22. Particularly, FIG. 22 depicts a block diagram of components of a machine learning training and inference system 2200 according to one or more embodiments described herein. The system 2200 performs training 2202 and inference 2204. During training 2202, a training engine 2216 trains a model (e.g., the trained model 2218) to perform a task, such as to identify potential failure regions and to improve process parameters to avoid failure relating to additive manufacturing. Inference 2204 is the process of implementing the trained model 2218 to perform the task, such as to identify potential failure regions and to improve process parameters to avoid failure relating to additive manufacturing, in the context of a larger system (e.g., a system 2226, the system 100 of FIG. 1). All or a portion of the system 2200 shown in FIG. 4 can be implemented, for example by all or a subset of the system 100 of FIG. 1, the processing system 2100 of FIG. 22, and/or the like, including combinations and/or multiples thereof.

The training 2202 begins with training data 2212, which may be structured or unstructured data. According to one or more embodiments described herein, the training data 2212 includes fabrication data, such as data collected by a sensor (e.g., a CIS) during fabrication of part/objects by an additive manufacturing system (e.g., the AMS 120). The training engine 2216 receives the training data 2212 and a model form 2214. The model form 2214 represents a base model that is untrained. The model form 2214 can have preset weights and biases, which can be adjusted during training. It should be appreciated that the model form 2214 can be selected from many different model forms depending on the task to be performed. For example, where the training 2202 is to train a model to perform image classification, the model form 2214 may be a model form of a CNN. The training 2202 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 2212 includes labeled images, including images of the object of interest with associated labels (ground truth) and other images that do not include the object of interest with associated labels. In this example, the training engine 2216 takes as input a training image from the training data 2212, makes a prediction for classifying the image, and compares the prediction to the known label. The training engine 2216 then adjusts weights and/or biases of the model based on results of the comparison, such as by using backpropagation. The training 2202 may be performed multiple times (referred to as “epochs”) until a suitable model is trained (e.g., the trained model 2218).

Once trained, the trained model 2218 can be used to perform inference 2204 to perform a task, such as to identify potential failure regions and to improve process parameters to avoid failure relating to additive manufacturing. The inference engine 2220 applies the trained model 2218 to new data 2222 (e.g., real-world, non-training data). For example, if the trained model 2218 is trained to classify images of a particular object, such as a chair, the new data 2222 can be an image of a chair that was not part of the training data 2212. In this way, the new data 2222 represents data to which the model 2218 has not been exposed. The inference engine 2220 makes a prediction 2224 (e.g., a classification of an object in an image of the new data 2222) and passes the prediction 2224 to the system 2226 (e.g., the system 100 of FIG. 1). The system 2226 can, based on the prediction 2224, taken an action, perform an operation, perform an analysis, and/or the like, including combinations and/or multiples thereof. In some embodiments, the system 2226 can add to and/or modify the new data 2222 based on the prediction 2224.

In accordance with one or more embodiments, the predictions 2224 generated by the inference engine 2220 are periodically monitored and verified to ensure that the inference engine 2220 is operating as expected. Based on the verification, additional training 2202 may occur using the trained model 2218 as the starting point. The additional training 2202 may include all or a subset of the original training data 2212 and/or new training data 2212. In accordance with one or more embodiments, the training 2202 includes updating the trained model 2218 to account for changes in expected input data.

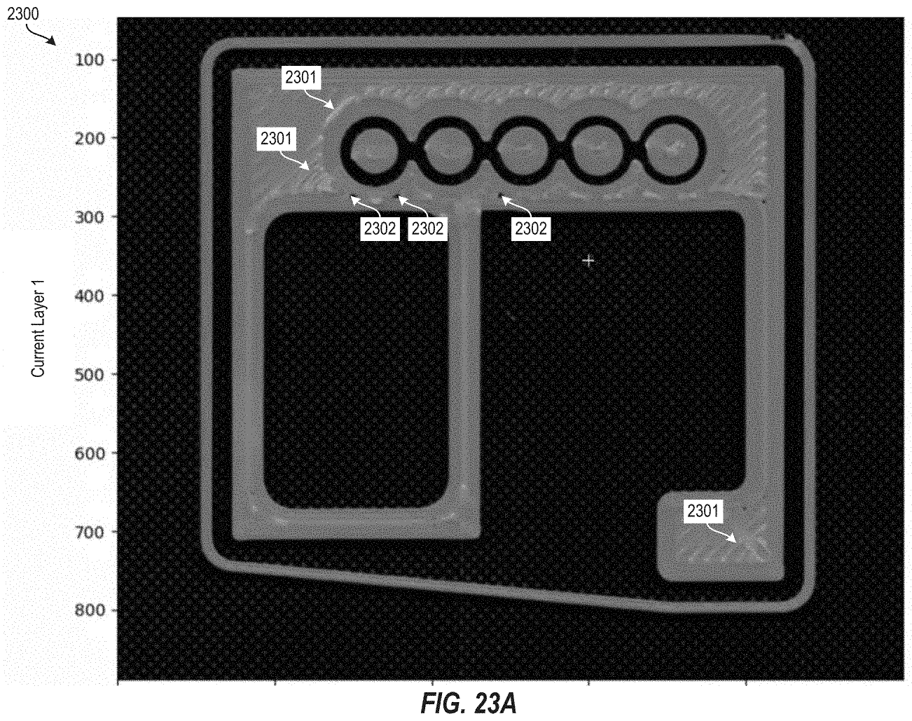

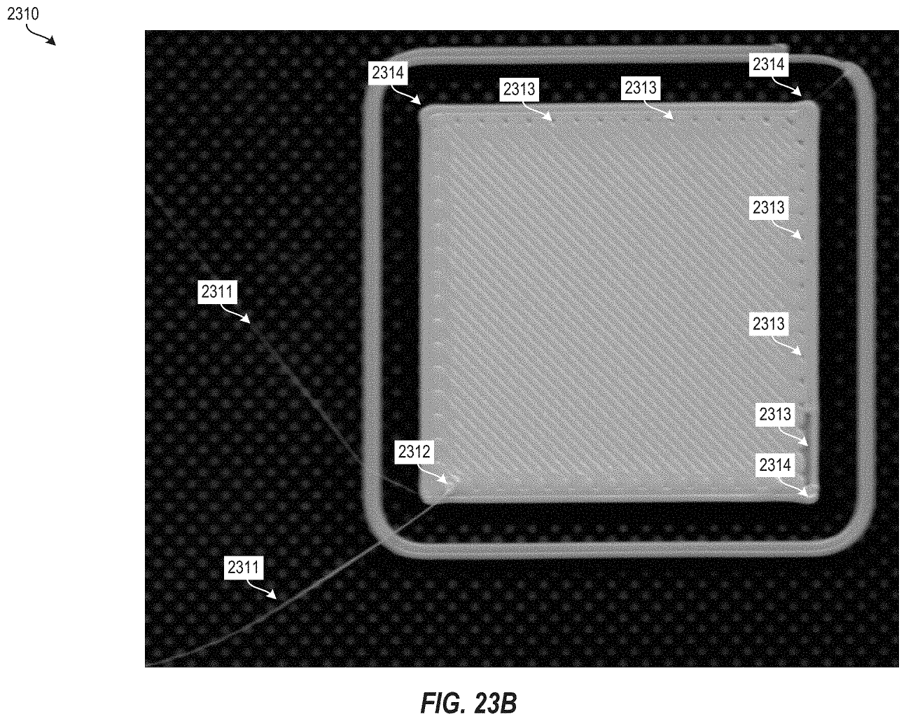

FIG. 23A depicts an image 2300 of a scan using a sensor (e.g., the sensor 122) of the internal features of a 3D printed part showing failures according to one or more embodiments described herein. The scan of the image 2300 represents the scan of a single layer of the part/object. The arrows 2301 point to areas where excess material was deposited, visible by the relatively lighter shading of green. The arrows 2302 point to areas where insufficient material was deposited, resulting in unintended holes. The image 2300 represents the same part shown in FIGS. 4, 7, 15, 17, and/or 20, for example.

FIG. 23B depicts an image 2310 of a scan using a sensor (e.g., the sensor 122) of the internal features of a 3D printed part showing failures according to one or more embodiments described herein. The scan of the image 2300 represents the scan of a single layer of the part/object. The arrows 2311 point to areas where stringing has occurred, the arrows 2312 point to areas where blobbing has occurred, the arrows 2313 point to areas where voids or under extrusion exist, and the arrows 2314 show out of square corners. The image 2310 represents the same part shown in FIGS. 5, 11, and/or 14, for example.

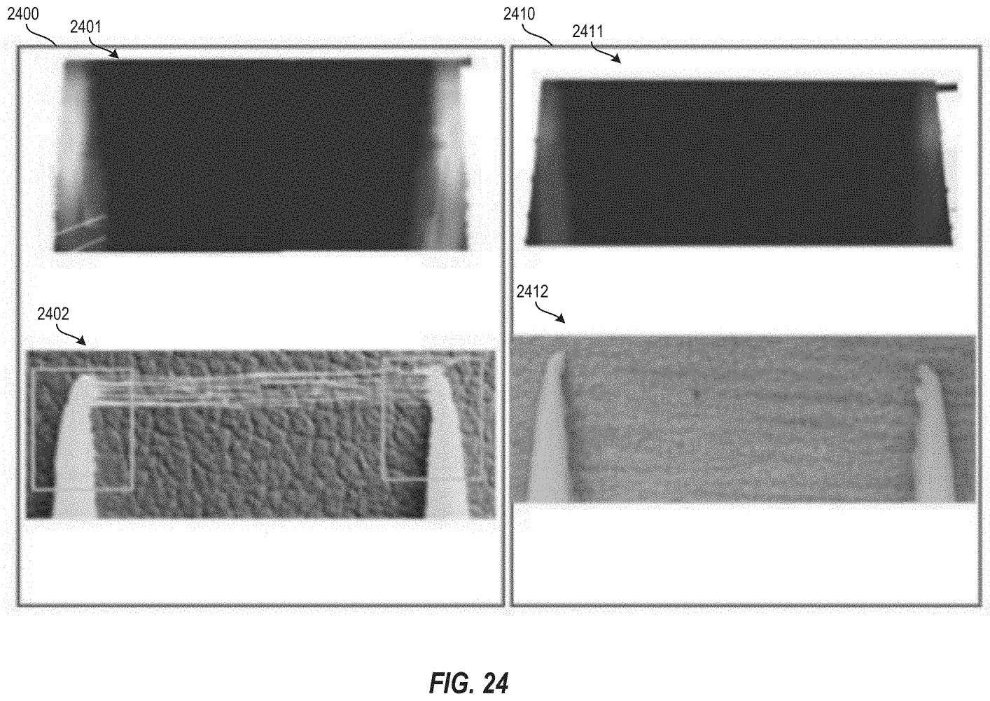

FIG. 24 depicts an example of the print results 2400 before the use of the simulation tool and the print results 2410 after corrections are made to the printing process according to one or more embodiments described herein. The print results 2400 include an image 2401 that shows the initial print detecting overmelt regions (shown in yellow). If the part is printed under these conditions, the results are shown in the image 2402, which shows overmelt regions in the printed part. By applying one or more of the techniques described according to one or more embodiments described herein, this defect can be reduced and/or eliminated. For example, the print results 2410 include an image 2411 that shows an initial print that does not include the overmelt regions, and the corresponding print shown in image 2412 does not include the overmelt defect. Thus, the image 2412 shows significantly reduced overmelt regions solved by editing print g-code and slicer settings as described herein.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% or 5%, or 2% of a given value.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method comprising:
receiving fabrication data from an additive manufacturing system during fabrication of an object by the additive manufacturing system, the fabrication data being collected by a sensor associated with the additive manufacturing system during the fabrication of the object;
generating a digital representation of the fabrication data;
adjusting, based at least in part on the digital representation, an aspect of the additive manufacturing system; and
implementing the adjusted aspect during the fabrication of the object by the additive manufacturing system.

2. The method of claim 1, wherein the sensor is a contact image sensor.

3. The method of claim 1, wherein the fabrication data is collected during the fabrication of a layer of the object.

4. The method of claim 3, wherein the adjusted aspect is implemented during the fabrication of the layer of the object.

5. The method of claim 3, wherein the adjusted aspect is implemented during the fabrication of a subsequent layer of the object.

6. The method of claim 1, wherein the fabrication data is collected after the fabrication of a layer of the object and before the fabrication of a subsequent layer of the object.

7. The method of claim 6, wherein the adjusted aspect is implemented during the fabrication of the subsequent layer of the object.

8. A method comprising:
receiving fabrication data from an additive manufacturing system, the fabrication data relating to a first fabrication job, the fabrication data being collected by a sensor associated with the additive manufacturing system during fabrication of an object;
generating a digital representation of the fabrication data;
analyzing the fabrication data against a theoretical result; and
causing a second fabrication job to be performed based on analyzing the fabrication data against the theoretical result.

9. The method of claim 8, further comprising training a machine learning model based at least in part on the fabrication data, wherein causing the second fabrication job to be performed is further based on an output of the machine learning model.

10. The method of claim 8, wherein the digital representation represents path of a print head of the additive manufacturing system during the first fabrication job.

11. The method of claim 10, wherein the path is represented based on a temperature of a print material extruded by the print head.

12. The method of claim 8, wherein the fabrication data comprise key process parameters.

13. The method of claim 12, wherein the digital representation represents the key process parameters.

14. The method of claim 8, further comprising analyzing the digital representation to detect a defect of an object fabricated during the first fabrication job.

15. A computer program product comprising a computer readable storage medium having program instructions embodied therewith, the program instructions executable by a processor to cause the processor to perform operations comprising:
receiving fabrication data from an additive manufacturing system during fabrication of an object by the additive manufacturing system, the fabrication data being collected by a sensor associated with the additive manufacturing system during the fabrication of the object;
generating a digital representation of the fabrication data;
adjusting, based at least in part on the digital representation, an aspect of the additive manufacturing system; and
implementing the adjusted aspect during the fabrication of the object by the additive manufacturing system.

16. The computer program product of claim 15, wherein the sensor is a contact image sensor.

17. The computer program product of claim 15, wherein the fabrication data is collected during the fabrication of a layer of the object.

18. The computer program product of claim 17, wherein the adjusted aspect is implemented during the fabrication of the layer of the object.

19. The computer program product of claim 17, wherein the adjusted aspect is implemented during the fabrication of a subsequent layer of the object.

20. The computer program product of claim 15, wherein the fabrication data is collected after the fabrication of a layer of the object and before the fabrication of a subsequent layer of the object, wherein the adjusted aspect is implemented during the fabrication of the subsequent layer of the object.
